(19) United States
(12) Patent Application Publication
(10) Pub. No.: US 2013/0191170 A1
(43) Pub. Date: Jul. 25, 2013

(54) KIOSK FOR PROVIDING INSURANCE SERVICES AND PRODUCTS

(71) Applicants: JOSHUA L. JARRETT, NASHVILLE, TN (US); MARC E. DIGIACOMO, HUDSON, OH (US)

(72) Inventors: JOSHUA L. JARRETT, NASHVILLE, TN (US); MARC E. DIGIACOMO, HUDSON, OH (US)

(21) Appl. No.: 13/750,322

(22) Filed: Jan. 25, 2013

Related U.S. Application Data
(60) Provisional application No. 61/590,454, filed on Jan. 25, 2012.

(51) Int. Cl. G06Q 40/08

(52) U.S. Cl. CPC G06Q 40/08
USPC 705/4

(57) ABSTRACT

A public access kiosk that provides direct, real-time communication between customers and licensed insurance agents, customer service representatives, or other insurance company representatives or agents. Communication may be voice only, with or without an avatar, but also may comprise face-to-face video. The kiosk is connected to the Internet or other network, thereby providing voice, video, and other data to be transmitted in real time and providing around-the-clock, automated (semi or fully) self-service, with an option for a fully supported, face-to-face in-office agency experience. The kiosk may be used to provide insurance and other services, including but not limited to providing a “lightning quote” for insurance in five minutes or less, and in some variations, in 60 seconds or less. A “lightning quote” also may be provided through the Internet or a web site, or other means.

This application claims benefit of and priority to U.S. Provisional Application No. 61/590,454, filed Jan. 25, 2012, by Joshua Jarrett and Marc DiGiacomo, and is entitled to that filing date for priority. The specification, figures and complete disclosure of U.S. Provisional Application No. 61/590,454 are incorporated herein by specific reference for all purposes.

### FIELD OF INVENTION

This invention relates to a device and related methods for providing direct insurance services and products, including insurance quotations, to customers. In one particular embodiment, this invention relates to providing direct insurance services and products, including insurance quotations, to customers through a kiosk.

### BACKGROUND OF THE INVENTION

Traditional distribution channels for providing insurance services and products comprise captive insurance agents or independent retail agents in a building or physical space, direct-to-consumer telephone call centers, or Internet web sites, whether or not optimized for mobile devices. The channels with personal interaction (i.e., real-time, face-to-face support) are limited in the number of distribution points. Internet web sites provide convenience, but require the consumer to have a computer and Internet connection. An example of a computer-based system for providing distance-based vehicle insurance is disclosed in U.S. Pat. No. 7,991,629, the complete specification, drawings and disclosure of which are incorporated herein by specific reference for all purposes.

### SUMMARY OF THE INVENTION

In various exemplary embodiments, the present invention comprises a public access kiosk that provides direct, real-time communication between customers and licensed insurance agents, customer service representatives, or other insurance company representatives or agents. Communication may be voice only, with or without an avatar, but in one embodiment may comprise face-to-face video. In an exemplary embodiment, the kiosk comprises one or more cameras or web-cams to provide video images of the customer using the kiosk, and the kiosk provides a video image of the agent or representative. In another embodiment, an avatar or digital spokes-avatar can be used for the agent or representative. The kiosk is connected to the Internet or other network, thereby providing voice, video, and other data to be transmitted in real time.

The kiosk may thus provide around-the-clock (24 hours, 7 days a week), automated (semi or fully) self-service, with an option for a fully supported, face-to-face in-office agency experience. The kiosk thereby blends the convenience and flexibility of fully automated self-service machines (e.g., ATMs), with the most appealing aspects of a traditional face-to-face meeting with an agent for counsel and support that a majority of insurance buyers (such as automobile insurance buyers) prefer. The kiosk may be equipped with privacy screens and sound baffling devices in order to keep the interaction relatively private. It also may be equipped with a handset for increased privacy and security.

The kiosk may be placed in multiple points or locations to provide convenient local or neighborhood access, enabling customers to quickly and conveniently address insurance needs as part of day-to-day activities without dedicating or remembering to make time for a special trip to an agent or an on-line session. Kiosks may be placed in locations with high customer traffic flow patterns, such as shopping malls, grocery stores, building lobbies, “big box” stores, drug-stores, gas stations, Department of Motor Vehicles, car dealerships, and the like. The kiosks may be unattended, and secured in a manner similar to ATMs and similar machines.

In one embodiment, a consumer may make payments for insurance products through the kiosk. Payments may be cash, credit card, check card, or any other means of making payments that are known in the art. Consumers may receive change for payments in cash.

In one exemplary embodiment, the consumer may use the kiosk for services (such as buying insurance, making payments, obtaining a quote, and the like) without using the real-time communication function. The real-time communication function may be initiated by the consumer when desired for advice, consultation, support, or assistance. In one embodiment, the customer representative or agent can remotely manipulate the kiosk and its screens on the customer's or user's behalf, while the customer or user watches and is engaged in discussion about what is happening. The kiosk also may initiate the real-time communication function under certain circumstances, such as when the consumer hesitates, back-tracks, is attempting manual data entry, or the like.

In various embodiments, the kiosk enables cash-paying or otherwise underbanked customers to easily consummate a complete range of web or phone business transaction with real-time face-to-face support at any one of a number of local, convenient locations. Thus, for example, a customer can obtain a quote on-line (as described below), then stop at a kiosk when convenient to pay for and bind coverage either in self-service mode or in the context of a real-time, face-to-face interaction with an agent. Alternatively, a consumer may simply stop at a kiosk and immediately engage in an interaction with the agent, describing the consumer's needs to the agent and allowing the agent to prepare and provide the quote. In yet another embodiment, the customer may complete the transaction on his or her own without any agent or representative intervention. The kiosk may provide documents to current or new customers, such as, but not limited to, a customer card (which may be a hard plastic card) and other documents related the transaction that was conducted (e.g., insurance ID card, receipts, policy documents, and the like).

Services available at a kiosk include quotes, new business policy application, policy endorsements, payments, reinstatements, re-writes, reporting claims, and other similar insurance services. Further, the kiosk system of the present invention may also be used for a variety of other products, such as financial services or products. In one embodiment, the kiosk system may be used to issue smaller loans, such as micro loans, payday loans, premium finance, and the like.

In yet another embodiment, the kiosk system may be used to offer and dispense gift cards for certain activities (e.g., making a payment, getting quote through the kiosk, and the like). The gift cards also may be branded for a specific location where the kiosk is placed or located, such that the host location has an incentive to allow the kiosk to be placed there.

The kiosk and system of the present invention provide a number of benefits to the company providing the insurance or other services. The present invention may be implemented at a substantially lower cost than traditional distribution channels. The number of local distribution points can be greatly increased over traditional distribution channels, and it can enable physical expansion into smaller and rural markets. The present invention also can promote brand awareness and image, with the brand name being omnipresent. The kiosks also may use a variety of “attract screens” and thus become, in effect, digital billboards. Further, placement of the kiosks in local stores will increase market penetration in the local market, with an increase in quote rates and hit rates.

In one exemplary embodiment, the kiosk system may provide a “lightning quote” feature. A “lightning quote” also may be provided through the Internet or a web site, an agent's office, company store, over the phone, through a call center, or any other means by which an insurance quote may be obtained. In one embodiment, the “lightning quote” system provides an auto insurance quote in five minutes or less. In another embodiment, the quote is provided in approximately 60 seconds or less using the efficient and logical integration of consumer data, and streamlined and well-organized rating rules, rating processes, custom software applications, and back-end processes. The consumer data may be prefilled data, which speeds the data entry process and also reduces the likelihood of error in data entry. While the discussion herein is in the context of an automobile insurance quote, the present system and methods can be applied to other insurance and insurance products.

### DESCRIPTION OF THE DRAWINGS

FIG. 1 shows a perspective view of a kiosk in accordance with an embodiment of the present invention.

FIG. 2 shows a front view of the kiosk of FIG. 1.

FIG. 3 shows a side view of the kiosk of FIG. 1.

FIG. 4 shows an example of a main screen of a system in accordance with an embodiment of the present invention.

FIGS. 5-49 show various views of screens from the system of FIG. 4.

### DETAILED DESCRIPTION OF EXEMPLARY EMBODIMENTS

In one exemplary embodiment, the present invention comprises a public access kiosk that provides direct, real-time communication between customers and licensed insurance agents, customer service representatives, or other insurance company representatives or agents. Communication may be voice only, with or without an avatar, but in one embodiment may comprise face-to-face video.

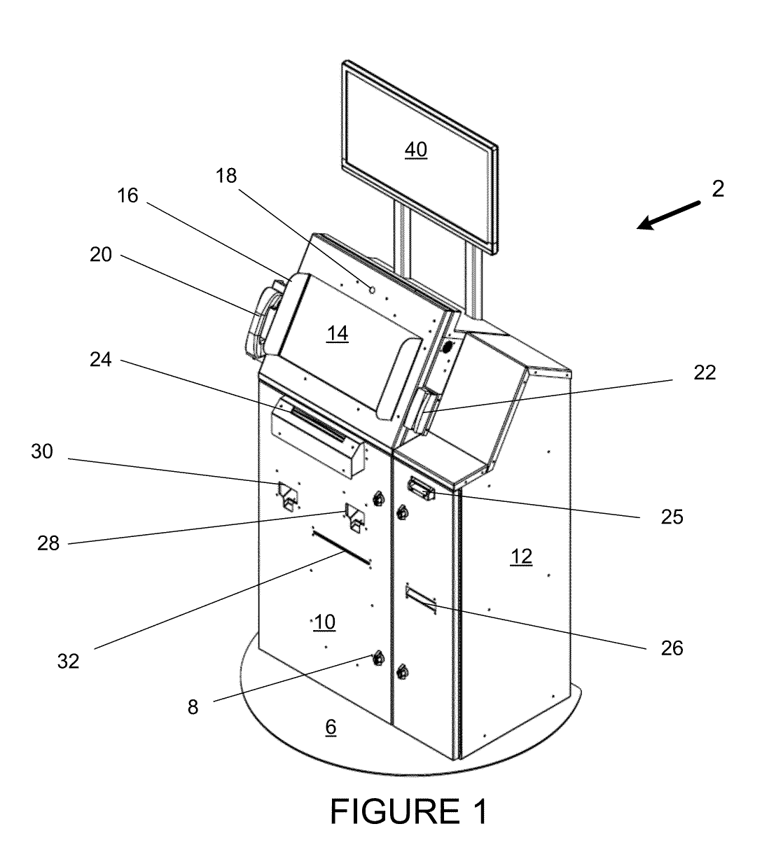

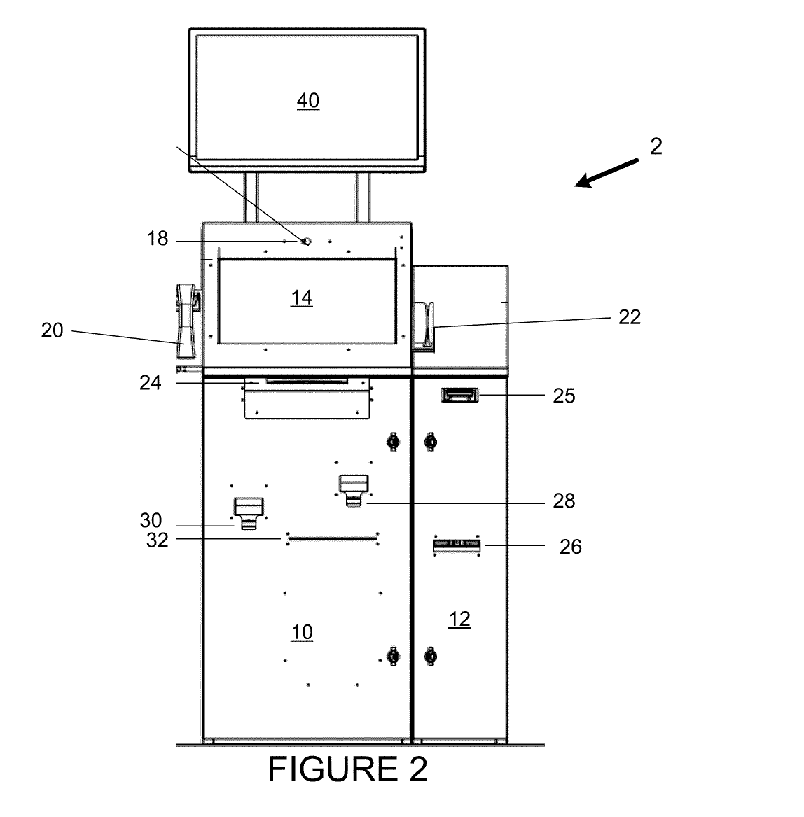

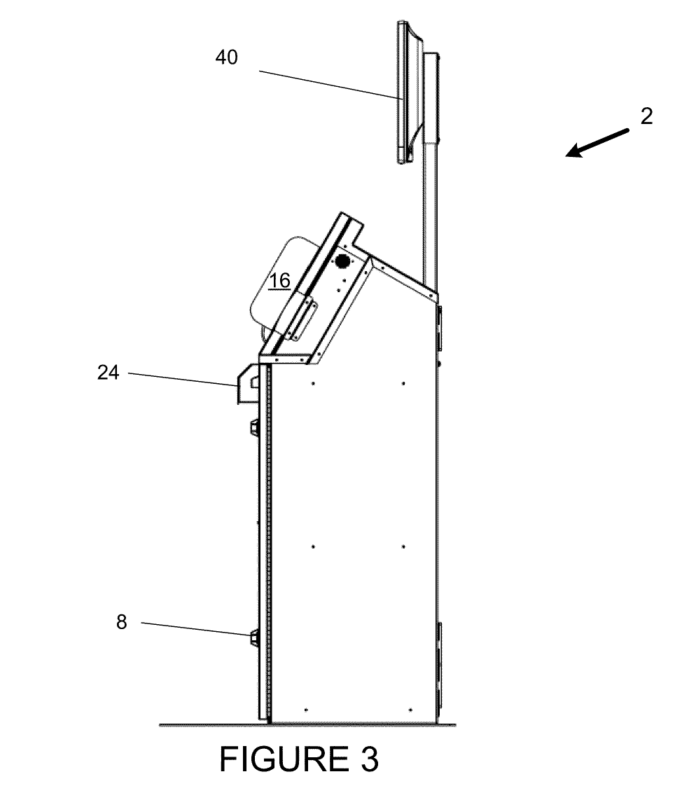

In one exemplary embodiment, as seen in FIGS. 1 through 3, the kiosk 2 comprises a cabinet 10 which securely houses the main components. The kiosk may comprise a single stand-alone cabinet 10, or a cabinet with a “sidecar” extension 12 connected to the main cabinet, and forming an extension thereto. The kiosk may sit on a base 6. The cabinet and sidecar may comprise one or more doors, which may be locked 8, allowing access to the interior. The interior of the cabinet (and sidecar, when present) contains a computer or computing device, paper or document printer, card printer, Internet connection, wireless router, scanning devices, power supply connectors (e.g., power cables or plugs, which may extend out from the kiosk), one or more speakers, power supply backup (such as one or more batteries), cash receiver and dispenser device, and the like. The cabinet may further comprise a main touchscreen display or monitor 14 (which may have one or more privacy screens or sound bafflers 16), a camera or webcam with a microphone 18, a telephone or phone handset 20, a bar code/magnetic stripe reader 22, a port for inserting documents to the scanner 24, an interface for receiving cash 25 and providing change 26, a port for dispensing a card printed by the card printer 28, a port for dispensing gift cards 30, and a port for dispensing printed documents 32. While this embodiment uses a touchscreen for user interaction, in some embodiments a keyboard or trackpad or trackball also may be provided, and the display screen may be a non-touch screen.

In several additional embodiments, the kiosk further comprises a secondary display screen 40. The secondary display screen may be a non-touch screen, and may serve as an “attract screen” as discussed below.

In one exemplary embodiment, where the customer or user is interacting with an insurance agent or representative, the kiosk uses one or more cameras or web-cams 18 to collect and provide video images of the customer using the kiosk, and the kiosk provides on the main display 14 a video image of the agent or representative. In another embodiment, a computer-generated avatar or digital spokes-avatar can be used for the agent or representative.

The kiosk is connected to the Internet or other network, either wired or wirelessly, or both, thereby providing voice, video, and other data to be transmitted in real time. The kiosk may thus provide around-the-clock (24 hours, 7 days a week), automated (semi or fully) self-service, with an option for a fully supported, face-to-face in-office agency experience. The kiosk thereby blends the convenience and flexibility of fully automated self-service machines (e.g., ATMs), with the most appealing aspects of a traditional face-to-face meeting with an agent for counsel and support that a majority of insurance buyers (such as automobile insurance buyers) prefer. The kiosk may be equipped with privacy screens and sound baffling devices 16 in order to keep the interaction relatively private. It also may be equipped with a telephone handset 20 for increased privacy and security in communications between the user and the agent/representative.

Kiosks may be placed in multiple points or locations to provide convenient local or neighborhood access, enabling customers to quickly and conveniently address insurance needs as part of day-to-day activities without dedicating or remembering to make time for a special trip to an agent or an on-line session. Kiosks may be placed in locations with high customer traffic flow patterns, such as shopping malls, grocery stores, building lobbies, “big box” stores, drug-stores, gas stations, Department of Motor Vehicles, car dealerships, and the like. The kiosks may be unattended, and secured in a manner similar to ATMs and similar machines.

In one embodiment, as described below, a consumer may make payments for insurance products through the kiosk. Payments may be cash, credit card, check card, or any other means of making payments that are known in the art (e.g., a consumer can inset bills into the cash receiving port 25, use a credit card with the magnetic stripe/barcode reader 22, or similar methods). Consumers may receive change through a port 26 where payments have been made in cash.

In one exemplary embodiment, the consumer may use the kiosk for services (such as buying insurance, making payments, obtaining a quote, and the like) without using the real-time communication function. The real-time communication function may be initiated by the consumer when desired for advice, consultation, support, or assistance. In one variation, the representative or agent can remotely manipulate the kiosk and its screens on the customer's or user's behalf, while the customer or user watches and is engaged in discussion about what is happening. The kiosk also may initiate the real-time communication function under certain circumstances, such as when the consumer hesitates, back-tracks, is attempting manual data entry, or the like.

Thus, in various embodiments, the kiosk enables cash-paying or otherwise underbanked customers to easily consummate a complete range of web or phone business transaction with real-time face-to-face support at any one of a number of local, convenient locations. Thus, for example, a customer can obtain a quote on-line or through another channel, then stop at a kiosk when convenient to pay for and bind coverage either in self-service mode or in the context of a real-time, face-to-face interaction with an agent. A customer also may stop at a kiosk to initiate and obtain a quote, and save it, then pay for and bind coverage online or at another location (such as by visiting an insurer's office or agent's office). Alternatively, a consumer may simply stop at a kiosk and immediately engage in an interaction with the agent, describing the consumer's needs to the agent and allowing the agent to prepare and provide the quote. The customer also may complete the transaction on his or her own without any agent or representative intervention. The kiosk may provide documents to current or new customers, such as, but not limited to, a customer card (which may be a hard plastic card) and other documents related the transaction that was conducted (e.g., insurance ID card, receipts, policy documents, and the like).

Services available at a kiosk include providing quotes, new business policy applications, policy endorsements, payments, reinstatements, re-writes, reporting claims, and other similar insurance services. Further, the kiosk system of the present invention may also be used for a variety of other products, such as financial services or products. In one embodiment, the kiosk system may be used to apply for, receive or issue smaller loans, such as micro loans, payday loans, premium finance, and the like.

In yet another embodiment, the kiosk system may be used to offer and dispense gift cards for certain activities in using the kiosk (e.g., making a payment, getting quote through the kiosk, and the like). The gift cards also may be branded for the specific location where the kiosk is placed or located, such that the host location has an incentive to allow the kiosk to be placed there (i.e., the consumer uses the kiosk, obtains the gift card for the host location, and uses it at the host location). The attract screen 40 may advertise the gift cards, thereby giving potential users an incentive to use the kiosk at that time in that particular location.

The kiosk and system of the present invention provide a number of benefits to the company providing the insurance or other services. The present invention may be implemented at a substantially lower cost than traditional distribution channels. The number of local distribution points can be greatly increased over traditional distribution channels, and it can enable physical expansion into smaller and rural markets. The present invention also can promote brand awareness and image, with the brand name being omnipresent. The kiosks also may use a variety of “attract screens” (which may be 27, 33 or 42 inches diag., or some other size), and thus become, in effect, digital billboards. Further, placement of the kiosks in local stores will increase market penetration in the local market, with an increase in quote rates and hit rates.

In one exemplary embodiment, the kiosk system may provide a “lightning quote” feature. A “lightning quote” also may be provided through the Internet or a web site, an agent's office, company store, over the phone, through a call center, or any other means by which an insurance quote may be obtained.

In one embodiment, the “lightning quote” system provides an auto insurance quote in 5 minutes or less (and in some exemplary embodiments, approximately 60 seconds or less) using the efficient and logical integration of consumer data, and streamlined and well-organized rating rules, rating processes, custom software applications, and back-end processes. The consumer data may be prefilled data, which speeds the data entry process and also reduces the likelihood of error in data entry. While the discussion herein is in the context of an automobile insurance quote, the present system and methods can be applied to other insurance and insurance products.

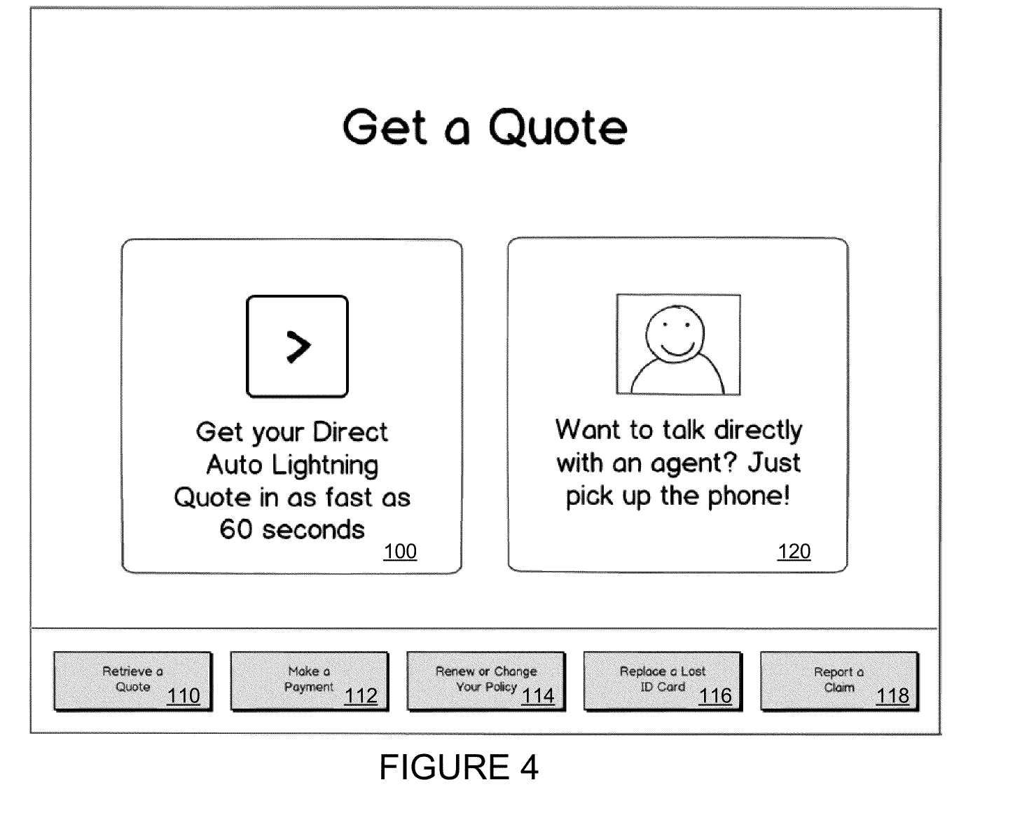

FIG. 4 shows an example of a main screen from a kiosk. The consumer may select the button or icon to obtain a quote 100, or may select an option from the menu to retrieve a previous quote 110 (which may have been initiated through the kiosk, another kiosk, or another channel, such as a computer at home), make a payment or reinstate a policy 112, renew or change a policy 114, replace an ID card 116, or report or file a claim 118. In other embodiments, the user also may bind a policy, endorse a policy, obtain a gift or loyalty card, or obtain premium financing or small or micro loans. The consumer also may opt to engage in a direct communication with an agent or representative 120, which may be through audio or screen interaction, or “face-to-face”. If an agent is available online for interaction with the user, then the user is presented with an option to speak directly with the agent.

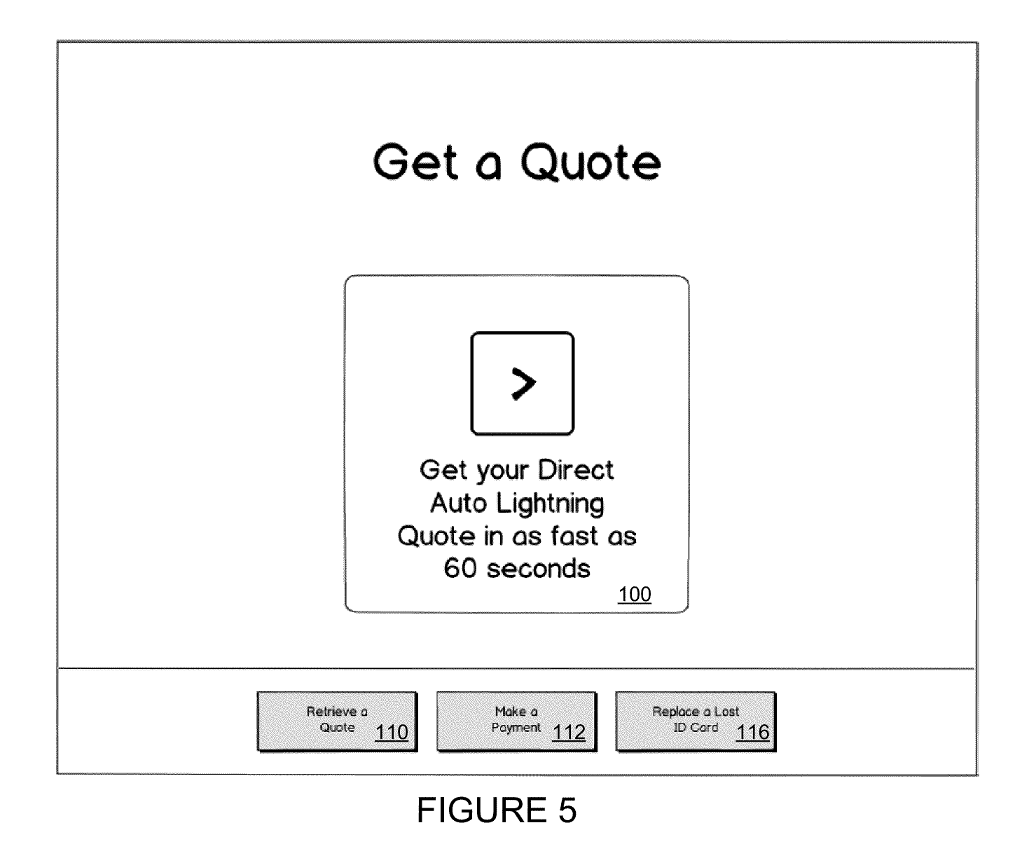

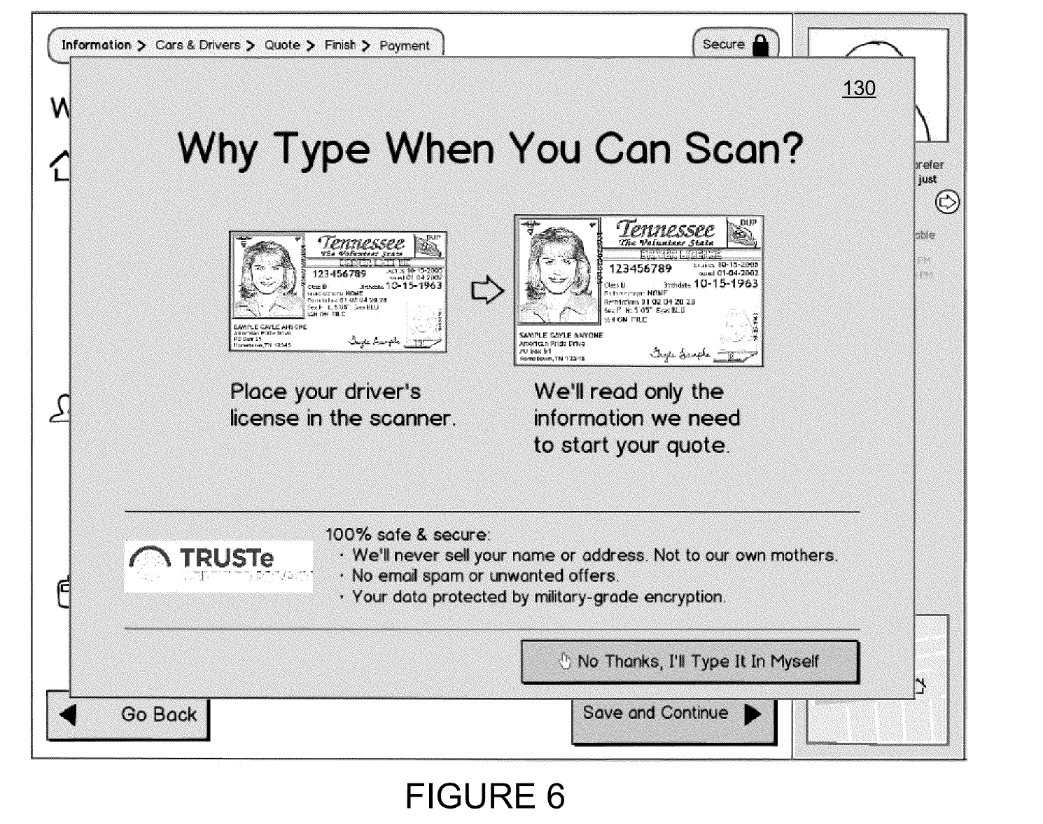

FIG. 5 shows an example of a system screen which is shown if the “get a quote” option is selected. The user can choose to proceed with the automatic system to get the quote. When the user selects the automatic quote option, he or she is presented with the option 130 to initiate the process with a scanned driver's license (as seen in FIG. 6), credit card, grocery chain customer card or tag, insurance statement or card, other insurance documents or bill, or similar card or object. The kiosk in this embodiment comprises a camera 18 or scanner 24, which the consumer then uses to scan the license, card, tag, or the like. Instructions, such as an instructional video, may be provided. A user at home may use a scanning device attached to their computer, if available, or a scanning or photograph feature in a mobile or smart phone, tablet computer, or similar device. The scanning allows identification information to be quickly retrieved with no data entry.

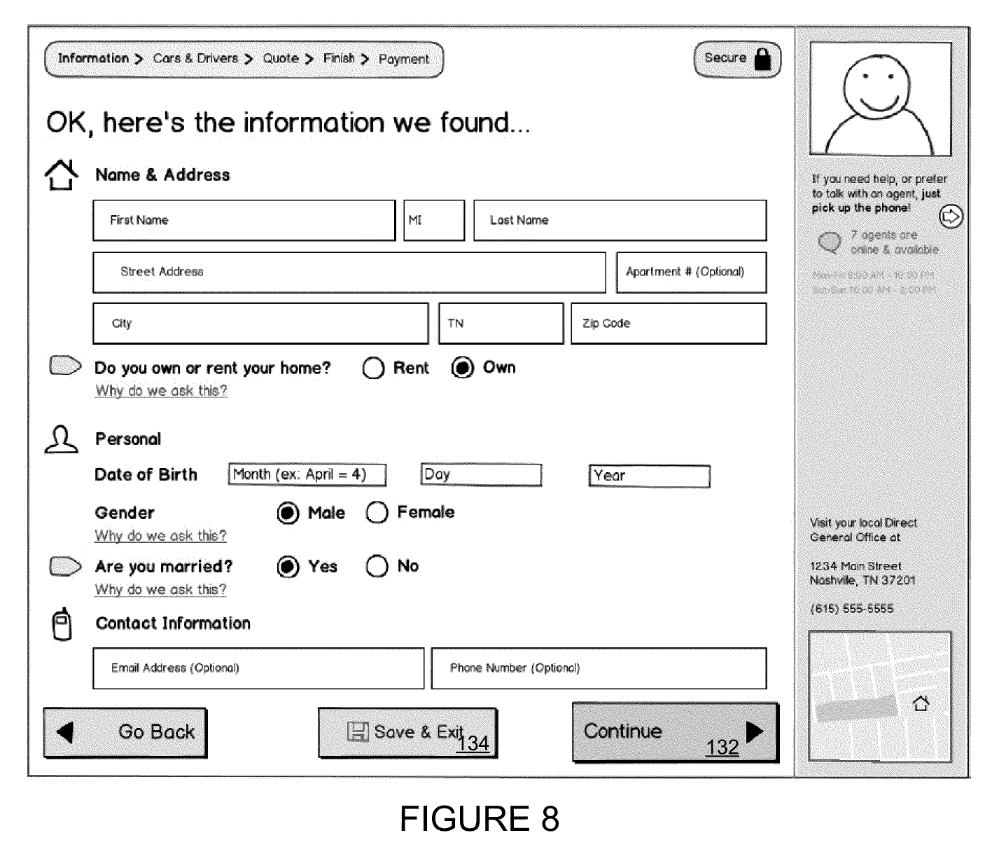

If scanning is used, the retrieved information is then presented to the user for review, confirmation and possible updating (as seen in FIG. 8). These system also may prompt the user to answer certain additional questions or fill in the answers for some questions without information. When ready, the user hits the “continue” button 132 to proceed with the process. Alternatively, at this and various other points, the user can instead select the option 134 to save the quote data to that point, and exit the process. The user can then later retrieve that information and continue the process from that point.

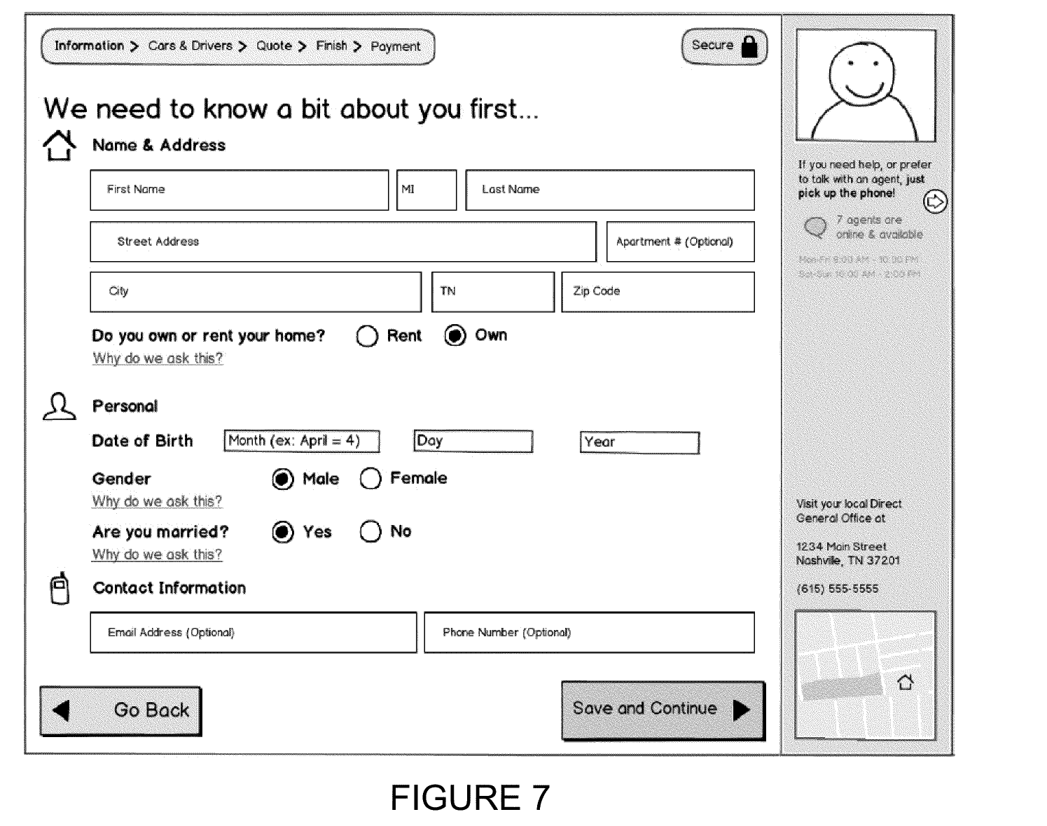

Alternatively, the user can opt to skip scanning, and type the information in himself or herself (as seen in FIG. 7). This screen also may be shown if the system is unable to retrieve information through the scanning process.

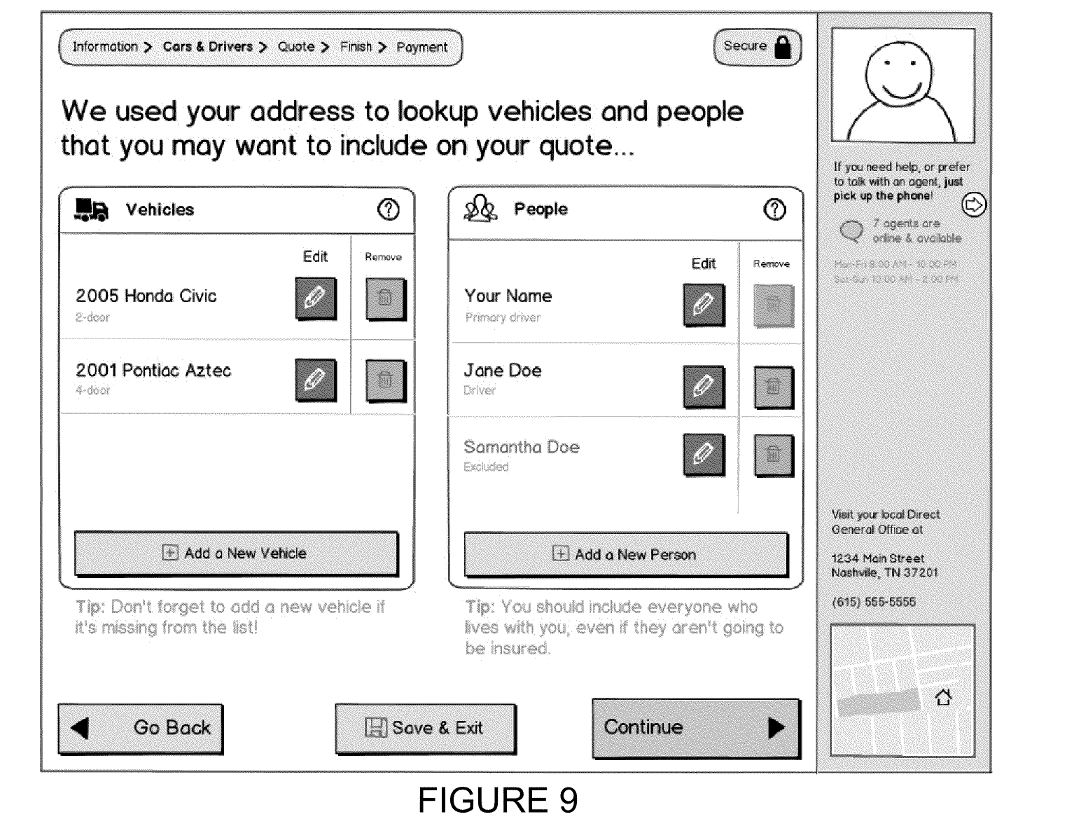

This information is then used by the system to retrieve driving-related information, as seen in FIG. 9. In one embodiment, a substantial portion of the data is prefilled, including driver data (for a number of drivers), membership data, vehicle data, current or prior insurance data, and the like. This eliminates a significant amount of manual entry of data (if not all), thereby speeding the data entry process and reducing the likelihood of input error.

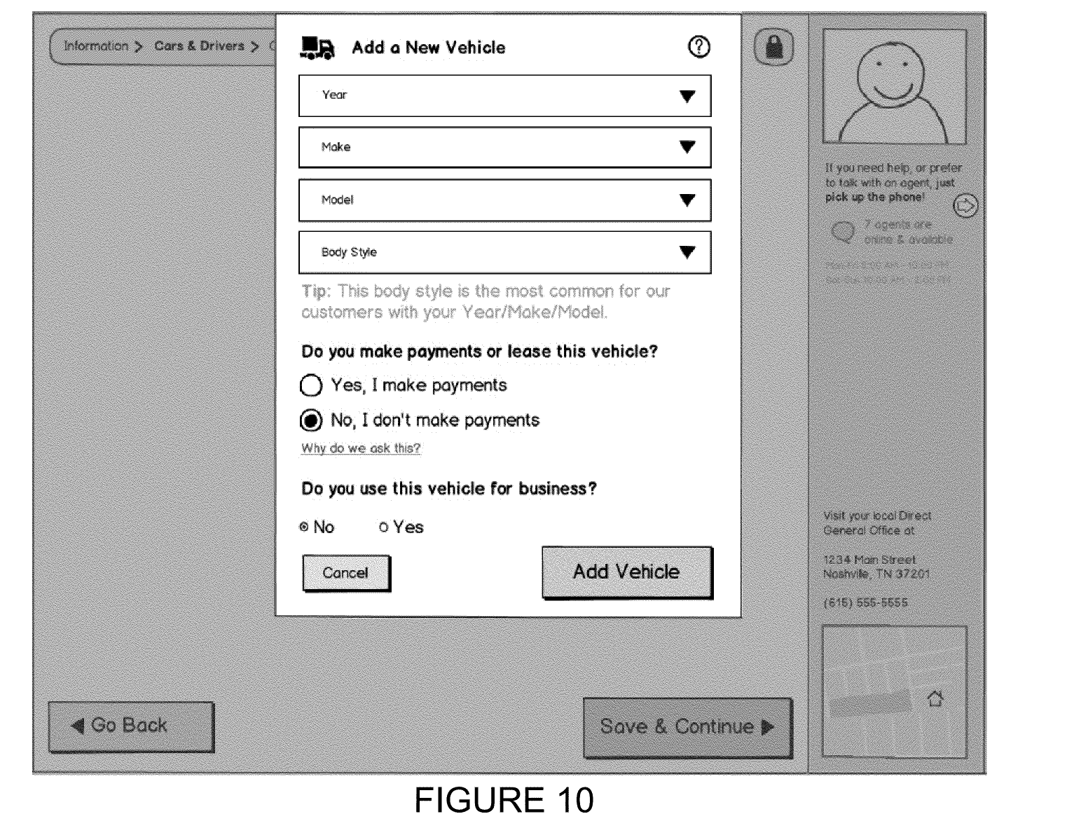

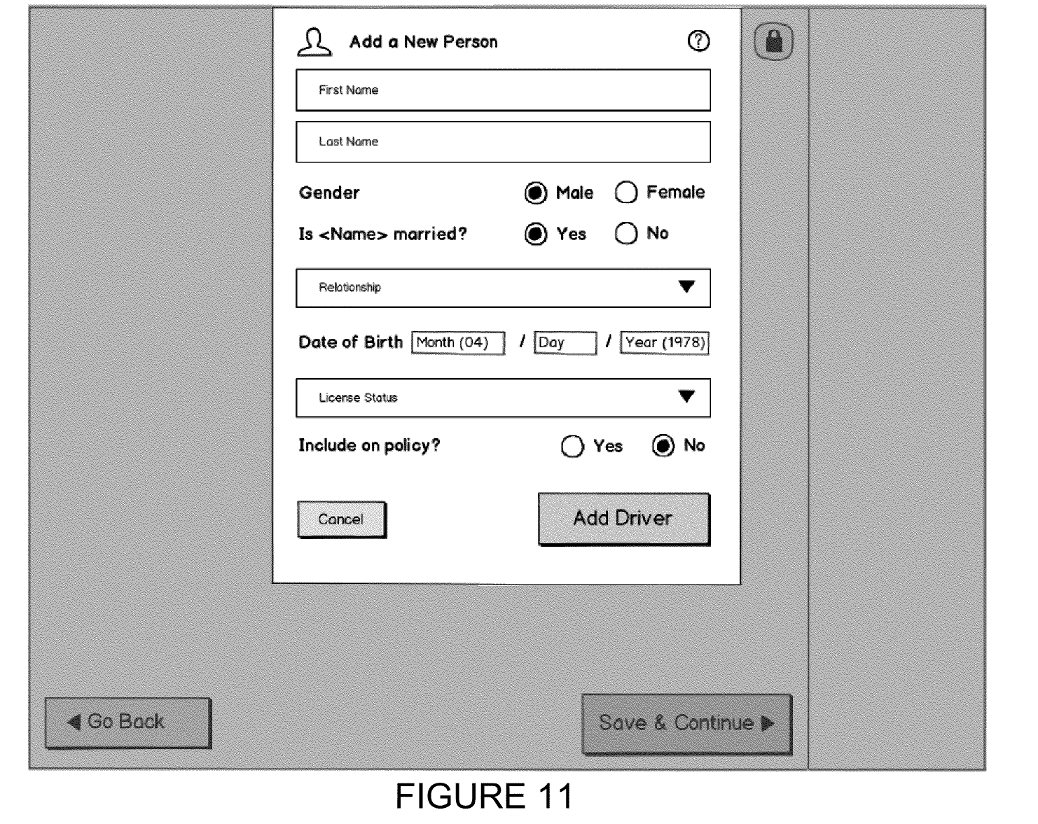

The user can update or correct this data (e.g., add a new vehicle, add a new person). Selecting these options presents the appropriate data entry screens to the user, as seen in FIGS. 10 and 11.

In one embodiment, the system causes certain windows or questions to appear or “pop-up” for the driving-related information. For example, the system may ask the user to indicate whether payments are being made on a vehicle, or if it is leased. Similar questions may be asked with regard to the drivers (e.g., spouse, child, parent, other). The continue button 150 may be “grayed-out” and unable to be used until all necessary questions have been answered.

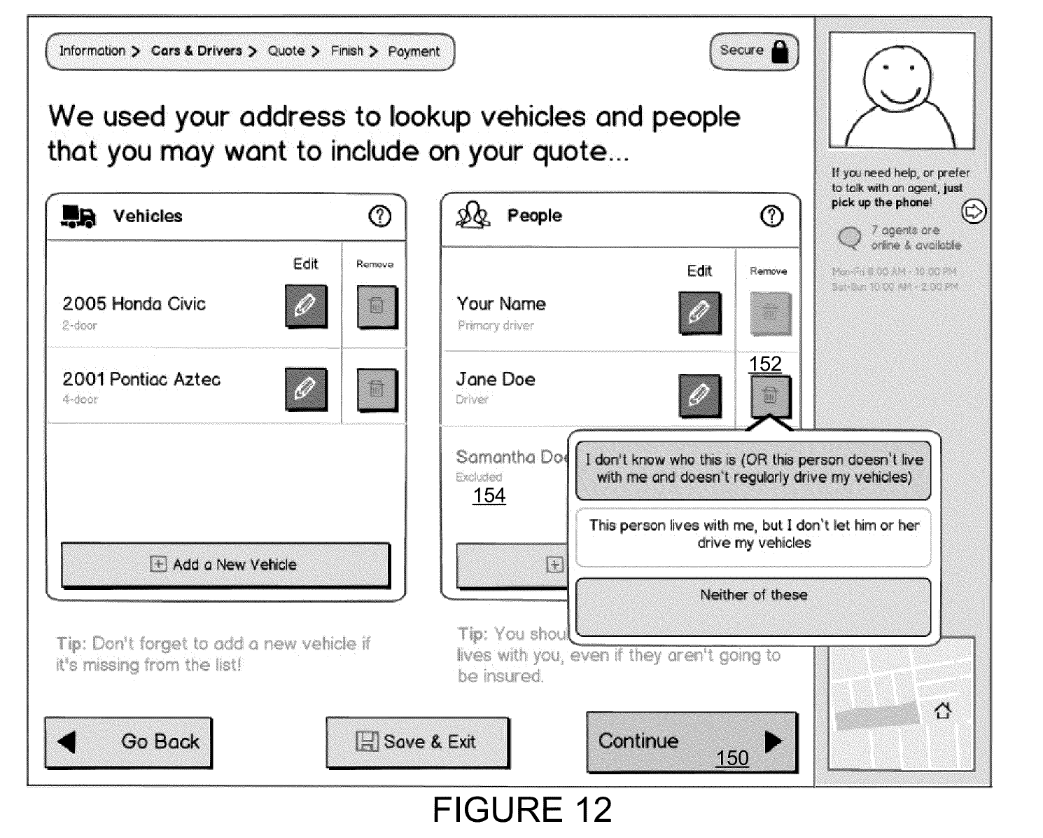

The user also may elect to remove certain drivers from coverage 152, and will be asked to identify the reason for the removal, as seen in FIG. 12. Drivers who have been removed from coverage may then be grayed-out on the list 154.

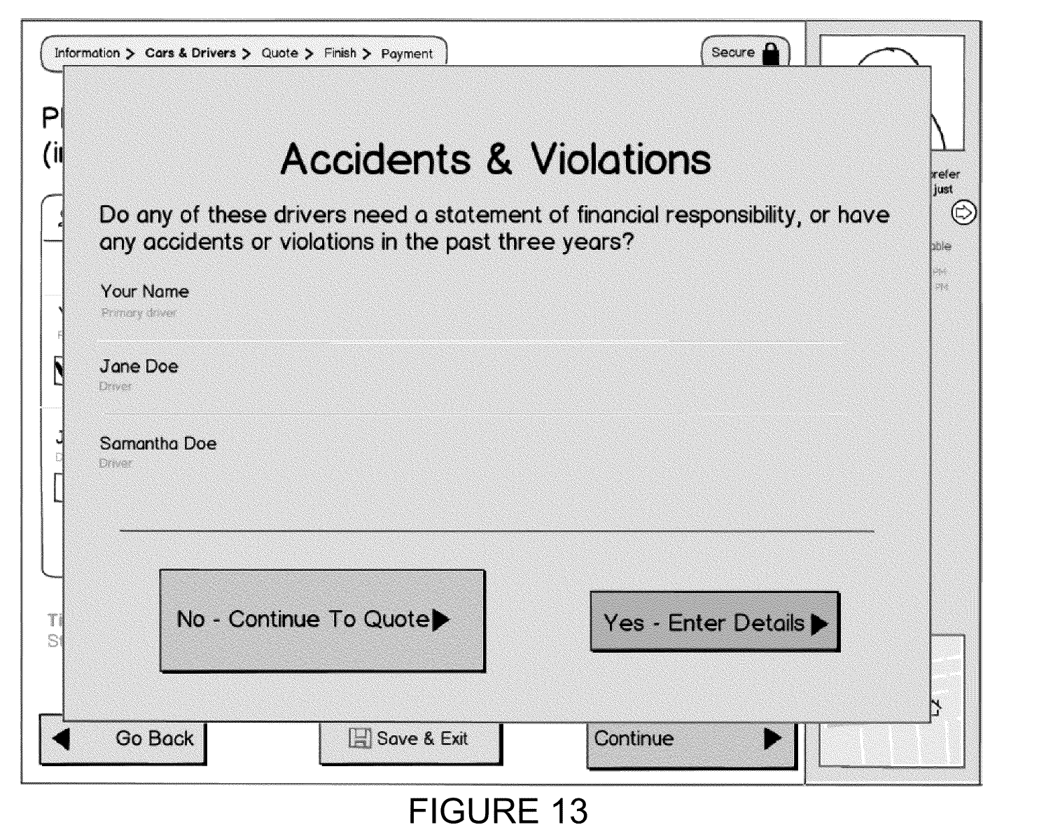

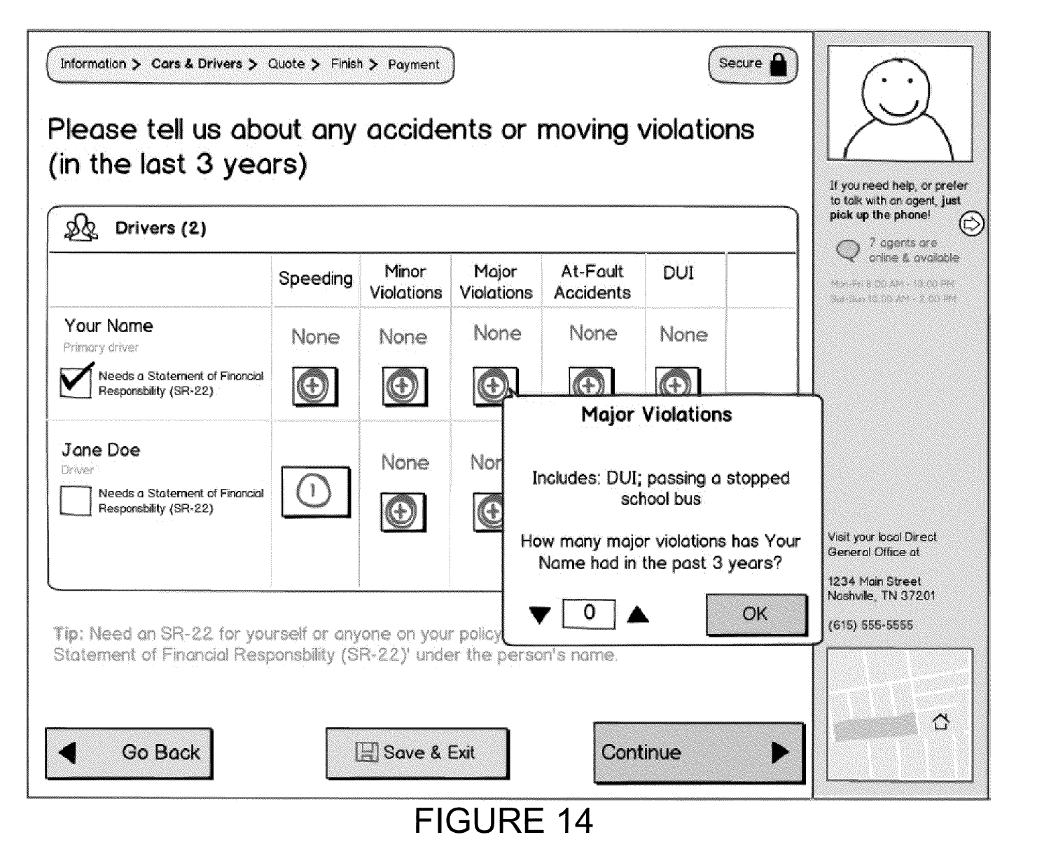

Upon continuing, the user is then prompted to enter any accident or moving violations within a certain period of time (e.g., the last three years, in the example shown in FIG. 13). The majority will have no violations or accidents, and can proceed by selecting the “no” button. If the answer is “yes,” then the user is prompted to enter details about the accidents and violations, as seen in FIG. 14.

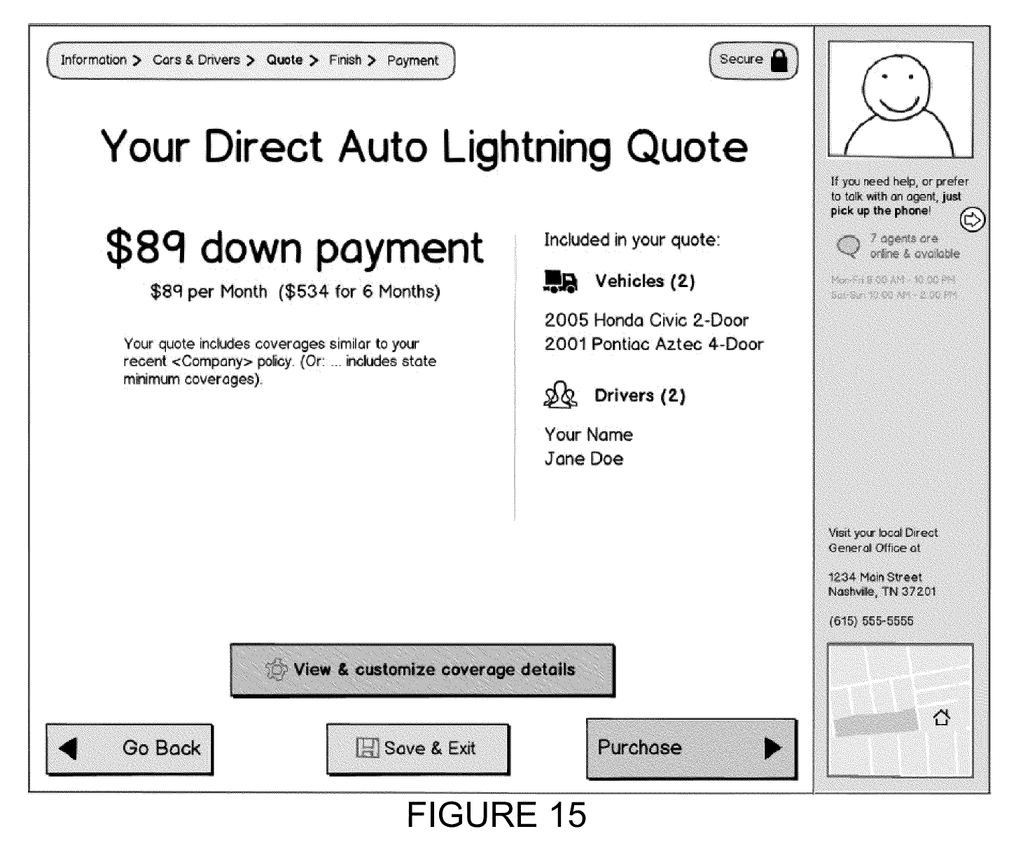

With prefilled consumer data and clean driving records, the user is provided an insurance quote. In one embodiment, the quote is provided in 5 minutes or less. In another embodiment, the quote is provided in approximately 60 seconds or less. A wait screen may be shown to the user while the quote is being prepared An example of a quote screen is shown in FIG. 15. The user can then save the quote for later processing, customize coverage details, or can choose to finalize and purchase the quote at that time to obtain insurance coverage. In one exemplary embodiment, the insurance quote is based on the consumer data, driving records and history, and previous coverage and history. Additional reports, such a credit report or motor vehicle records (MVR) report, may be obtained to increase the accuracy of the quote.

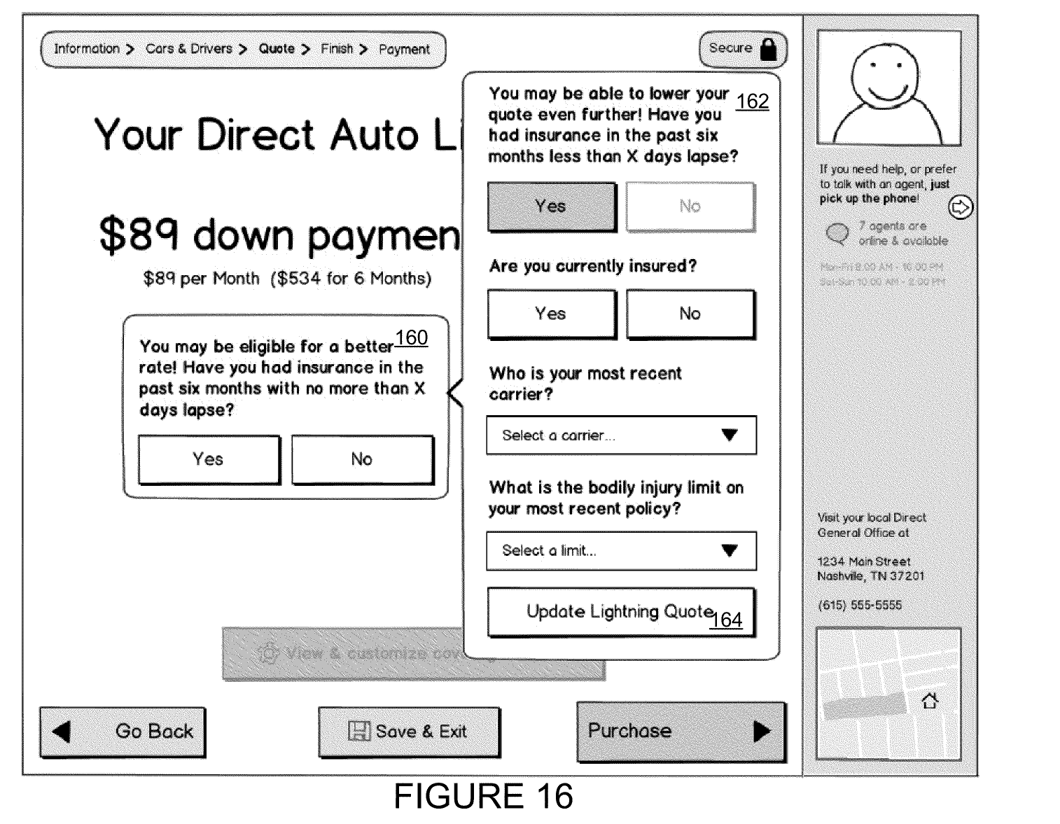

In one embodiment, the system provides the user a prompt to inquire whether they may be eligible for a better insurance rate 160, as seen in FIG. 16. The user is then prompted to answer a series of questions 162 that may help identify areas that may lead to a lower rate quote. The questions are answered, and the user then asks for the quote to be updated 164.

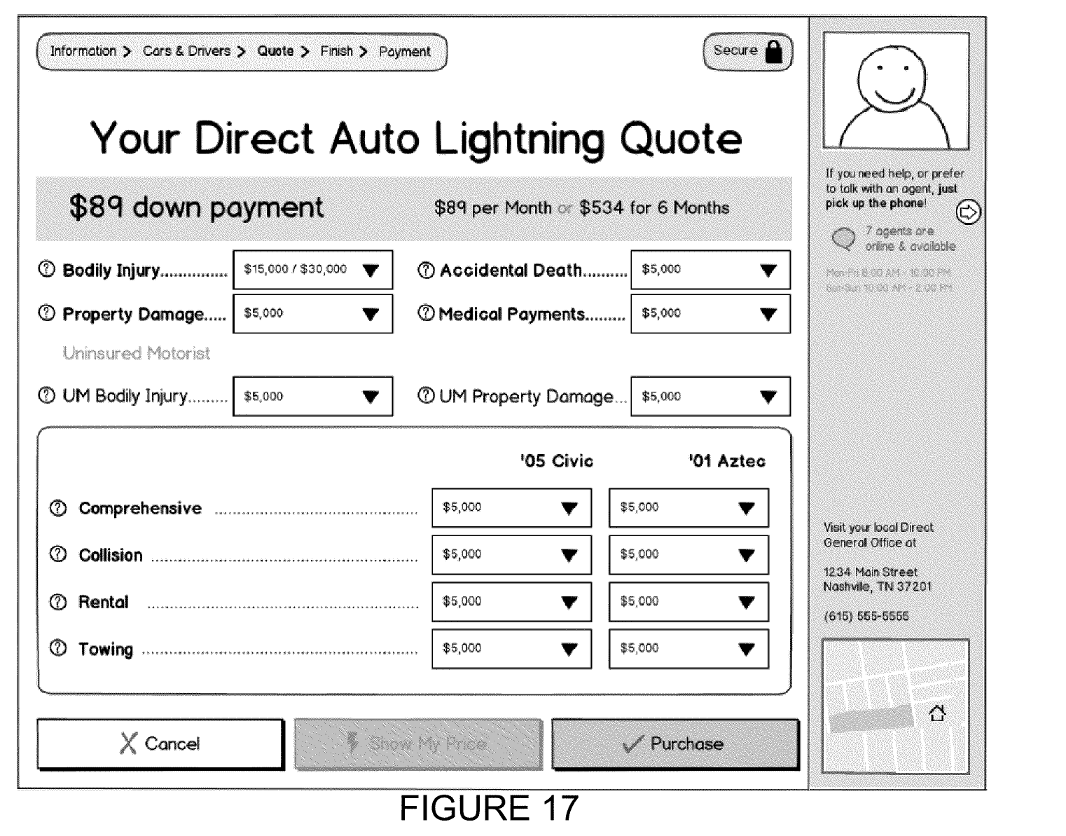

The user also may be prompted to view and customize coverage details. Upon choosing this option, the user is presented with detailed information about the insurance coverage, such as types and amounts of coverage, as seen in FIG. 17.

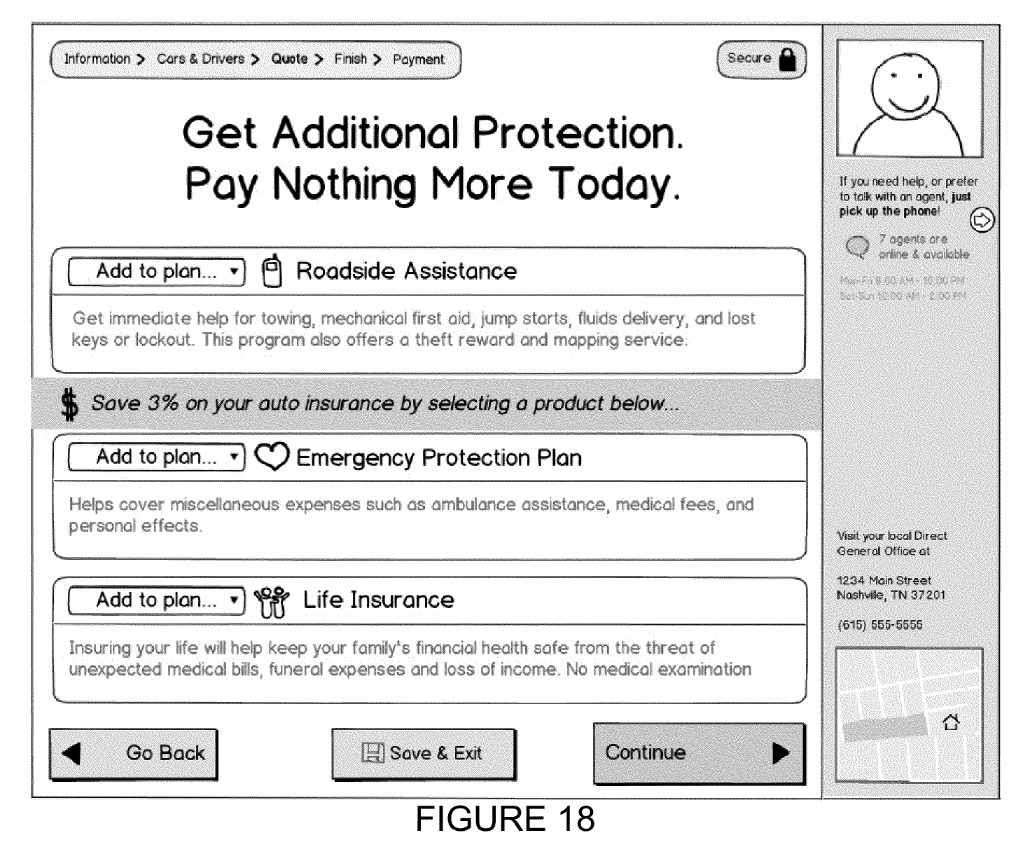

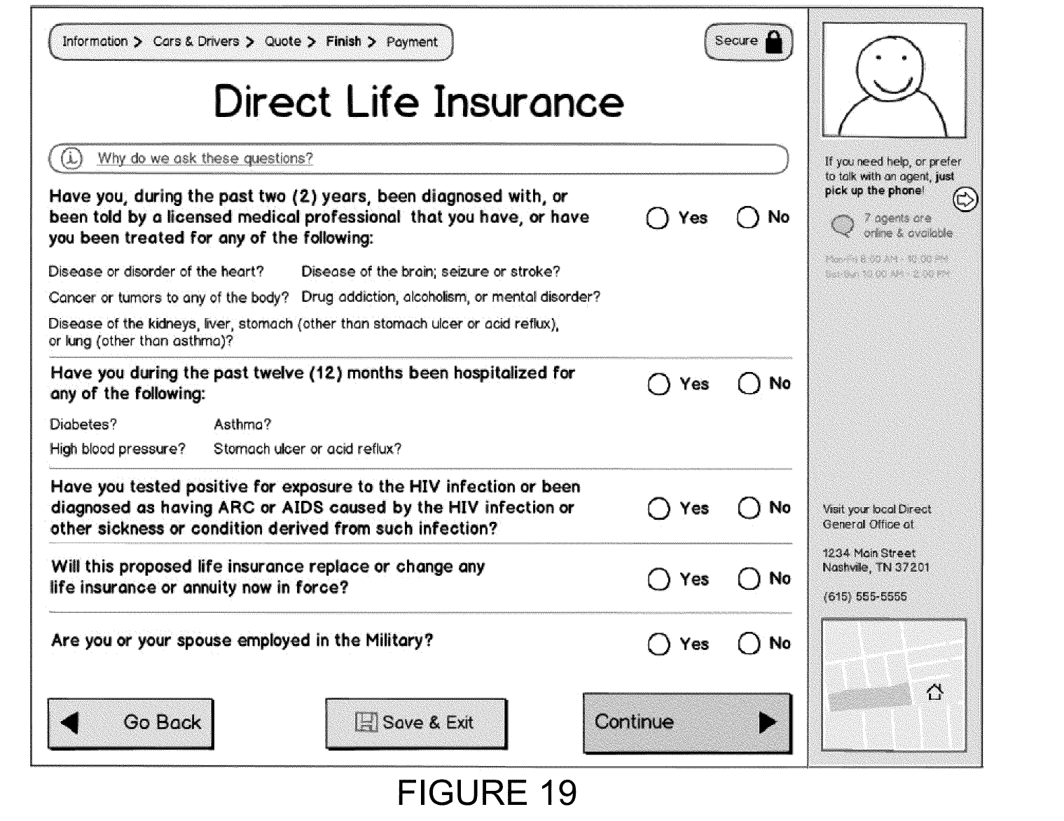

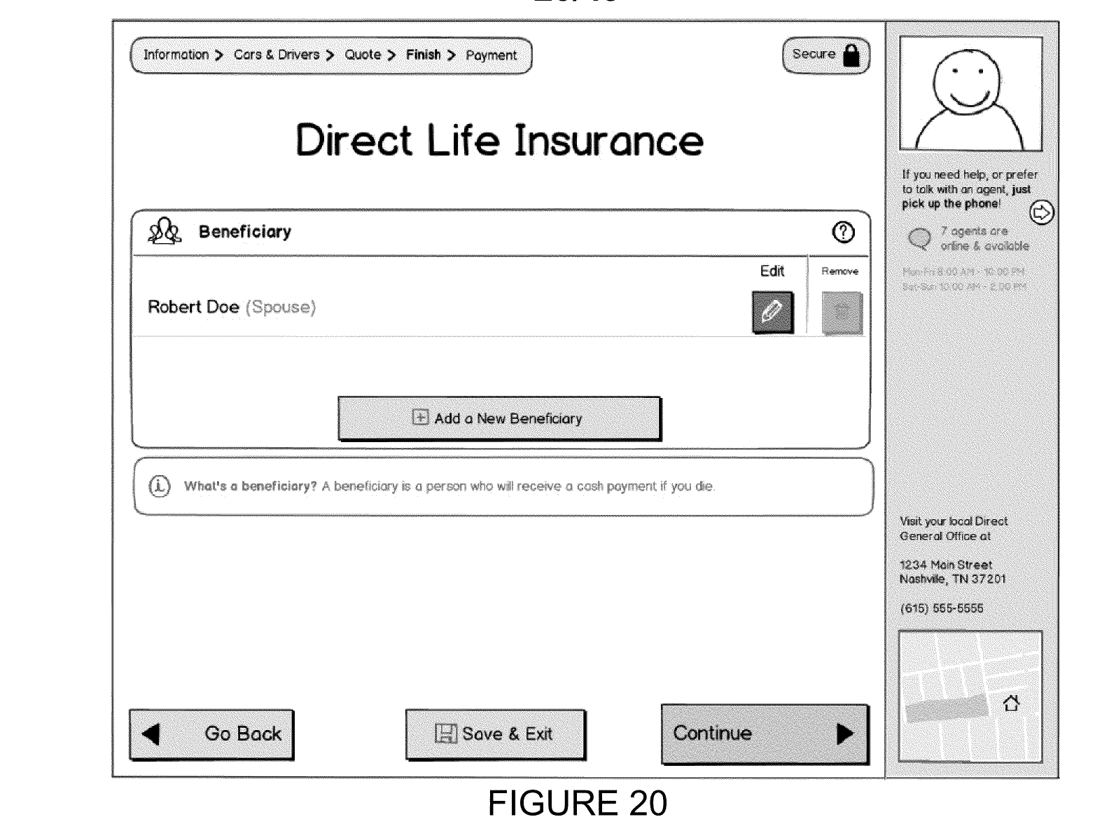

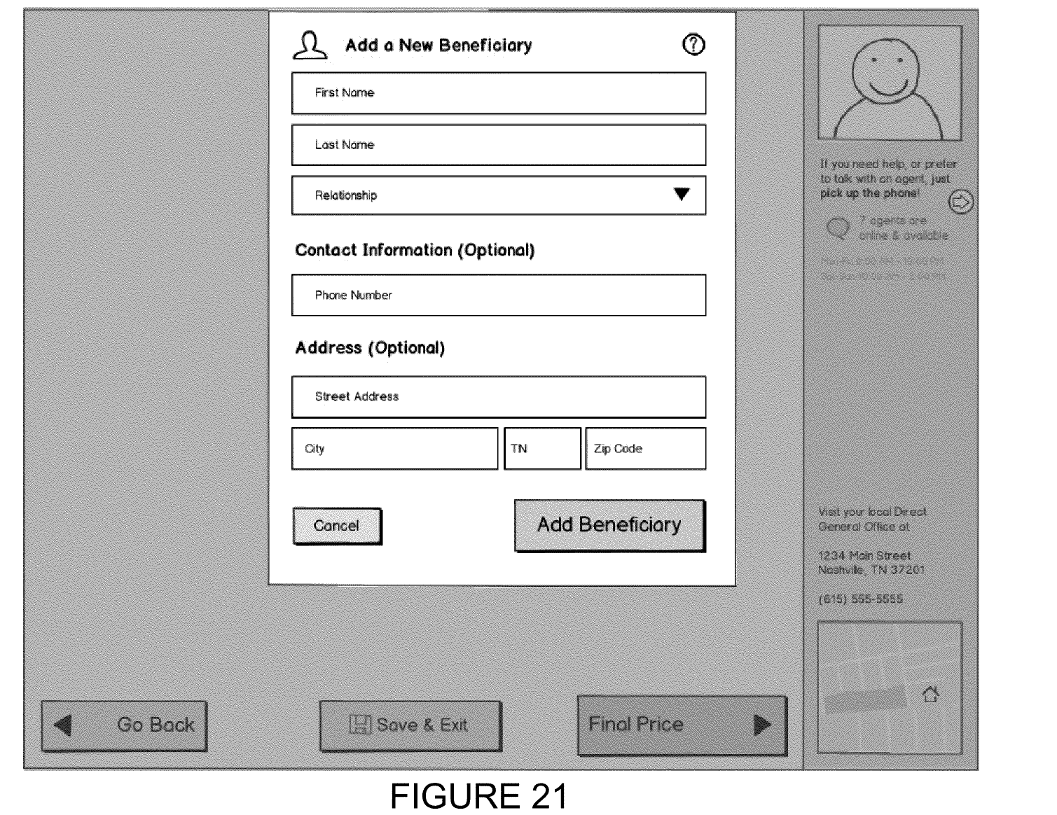

The user also may be offered options to add additional elements to their protection plan, such as roadside assistance, emergency coverage, or life insurance, as seen in FIG. 18. If any of these options are selected, additional information may be solicited. FIGS. 19-21 shows information solicited for life insurance, for example. Some of the answers may preclude obtaining life insurance through the system, and the system will then ask if the user would like to speak with an agent.

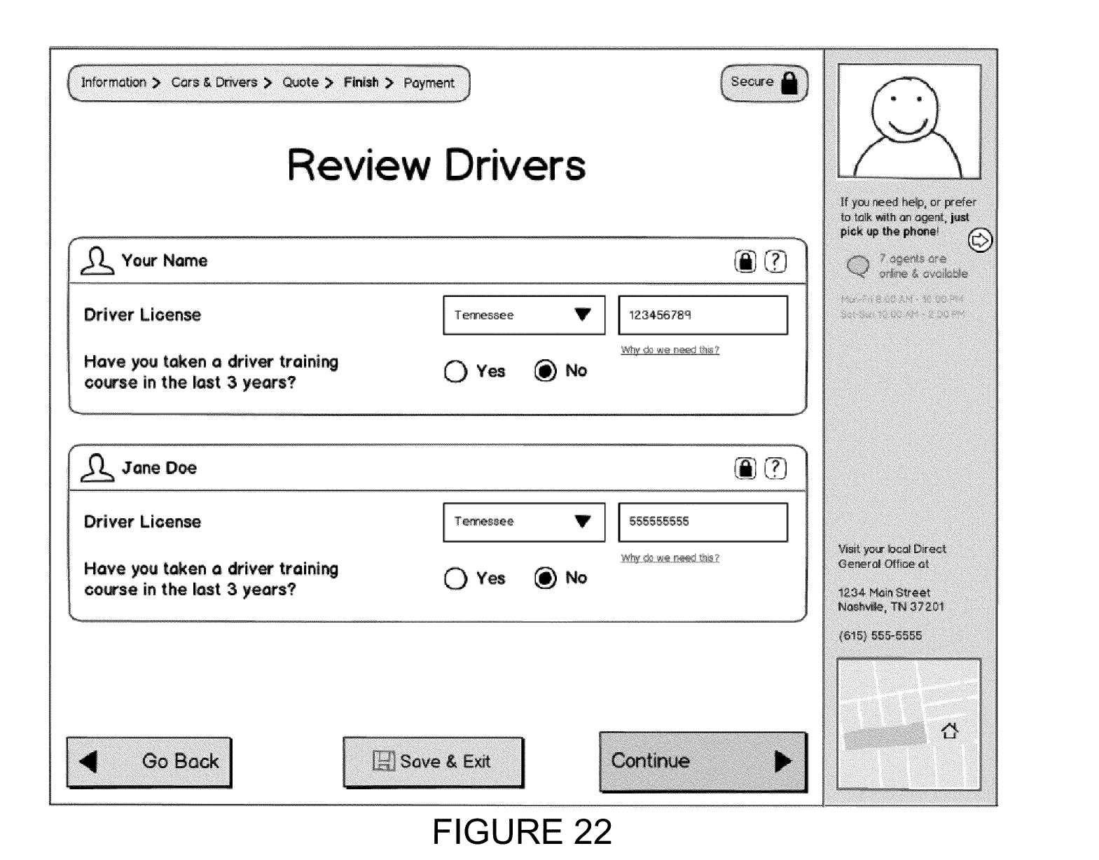

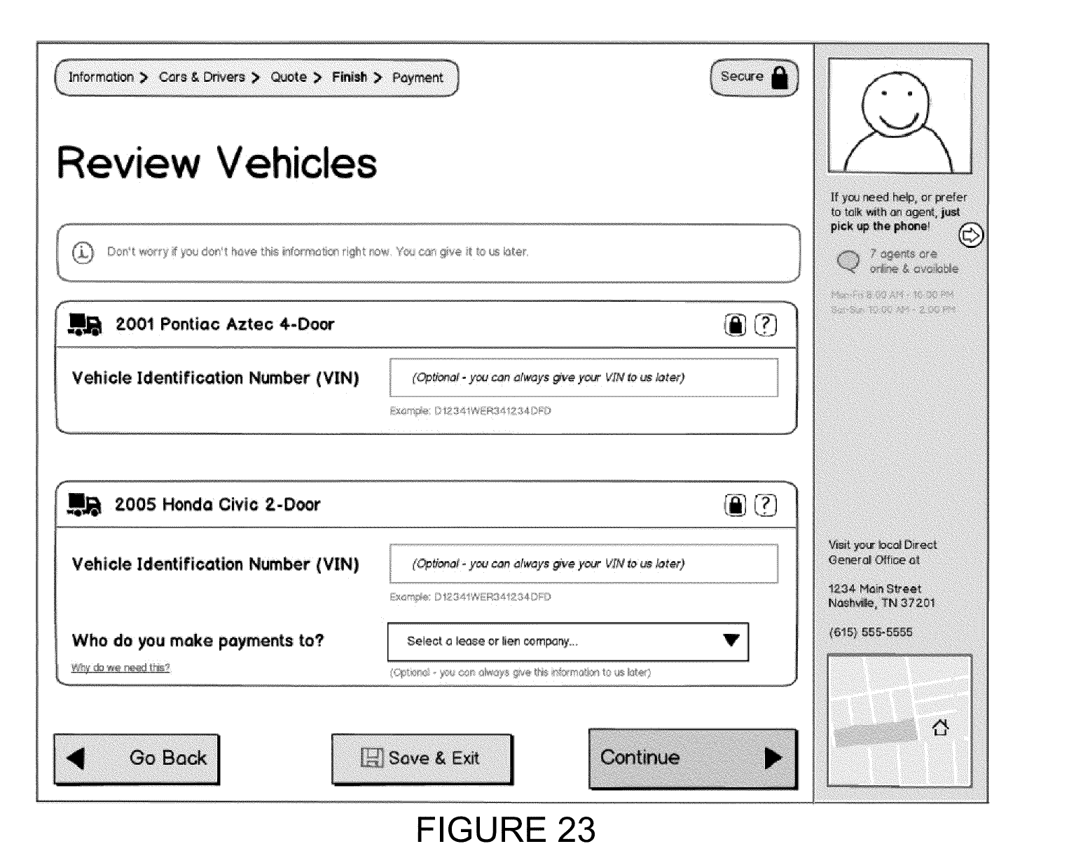

During the process, the user may be asked by the system to review or provide additional information on some or all of the drivers and vehicles, and in some cases, respond to certain questions about them, as seen in FIGS. 22-23. This may be done in order to complete the purchase of an insurance policy.

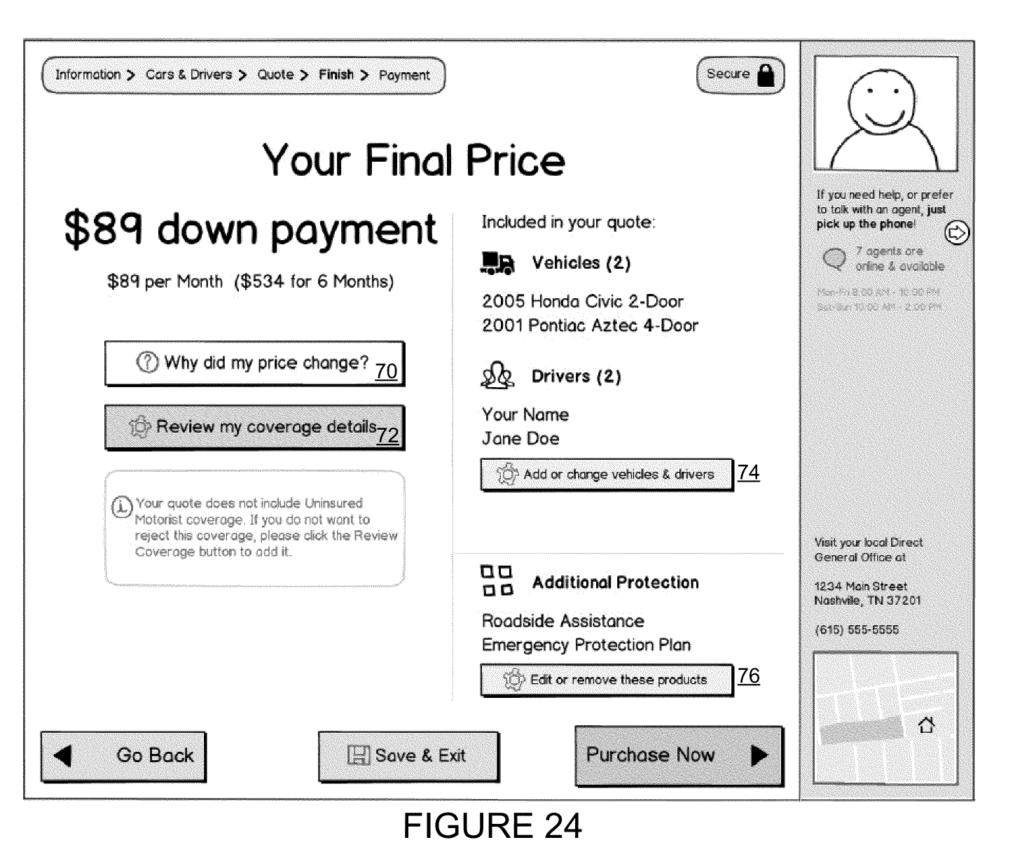

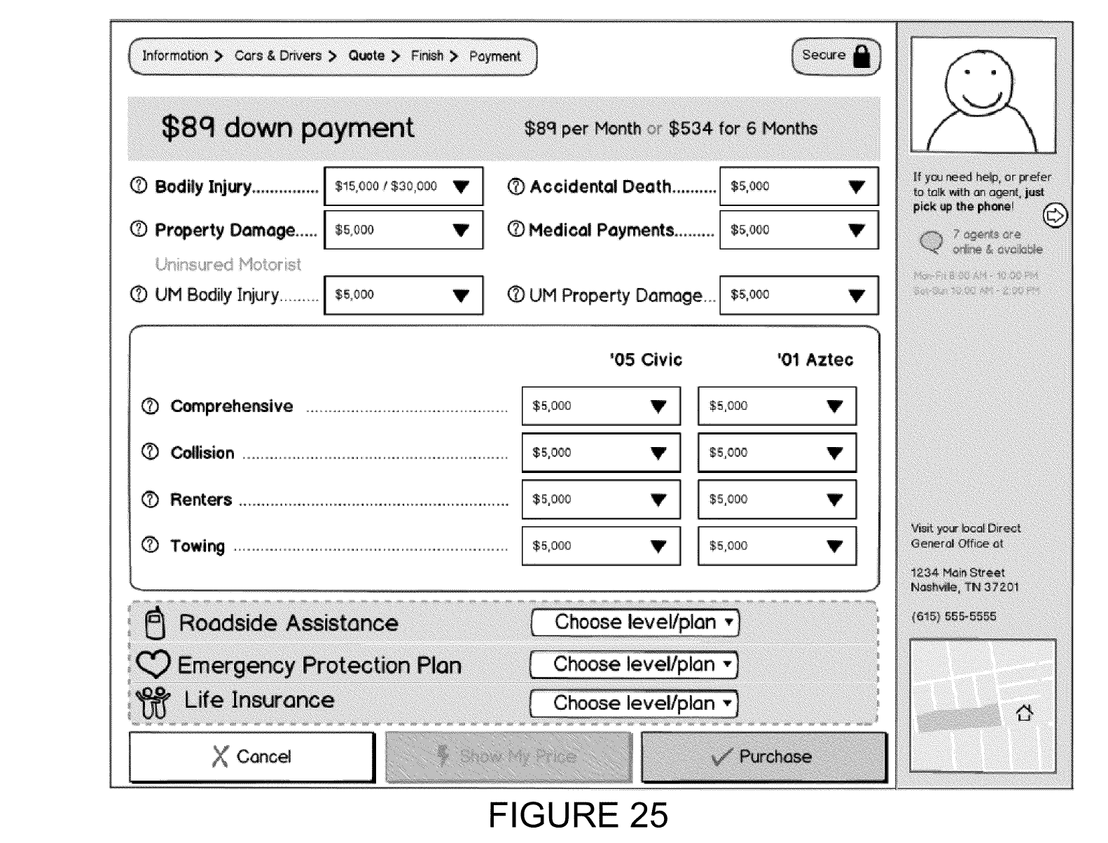

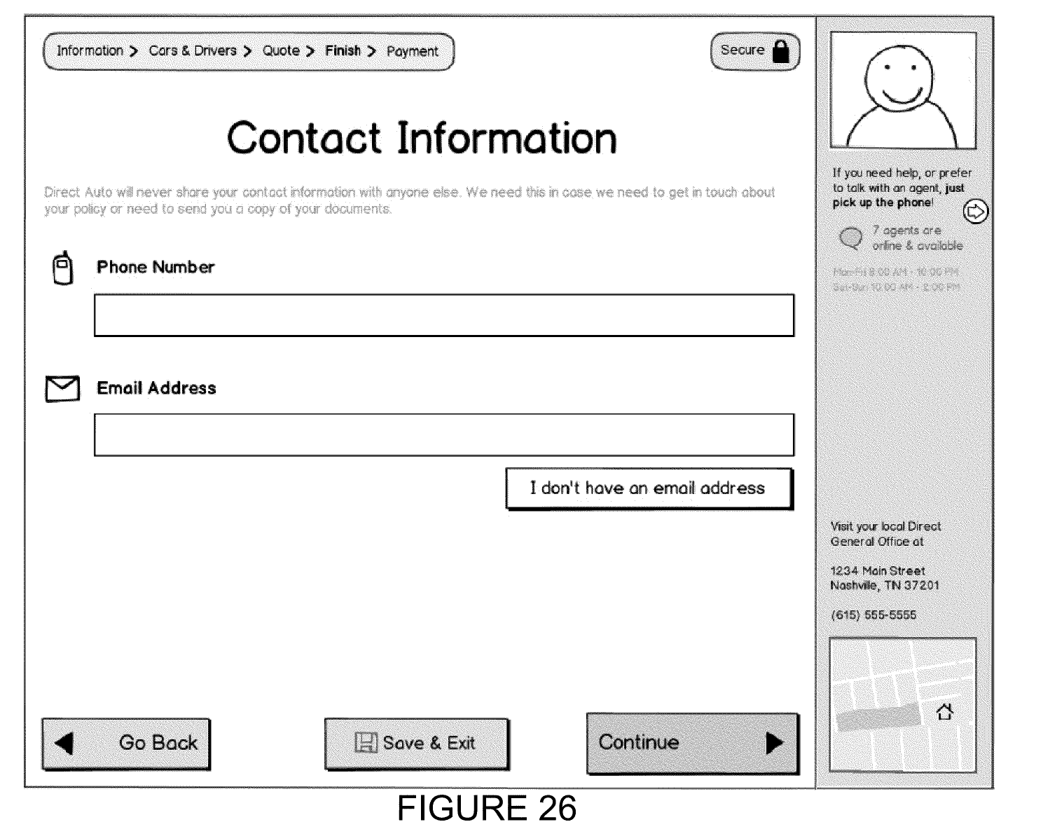

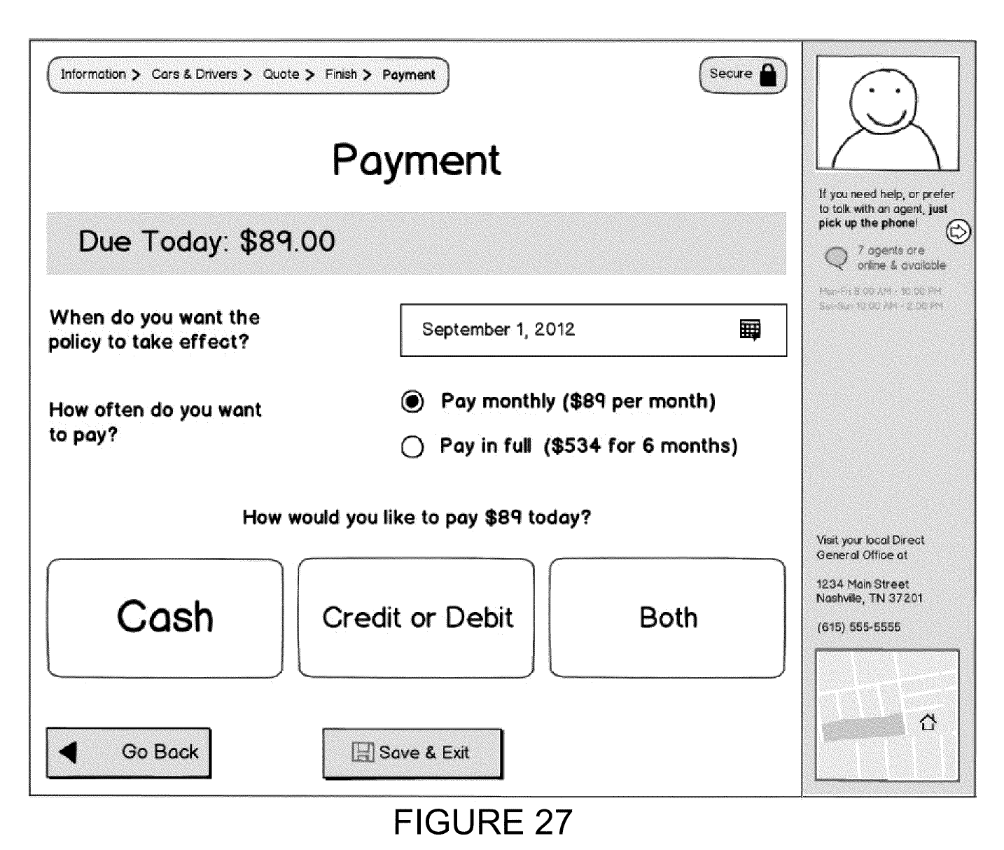

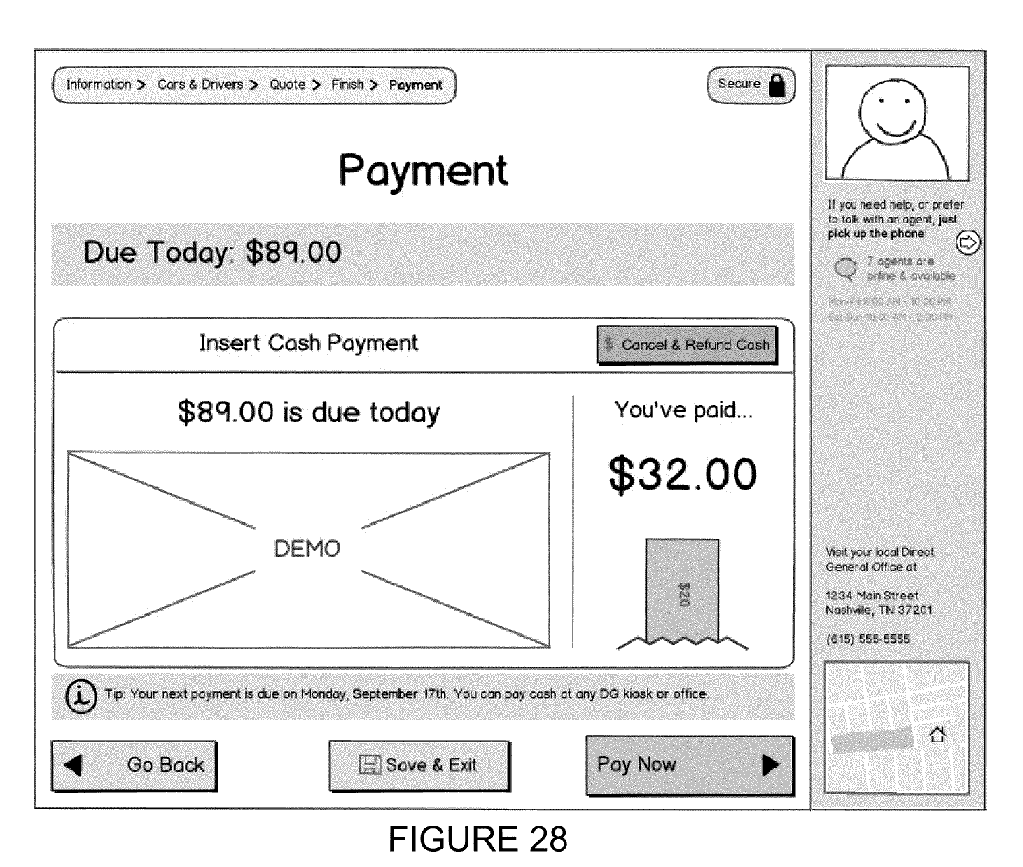

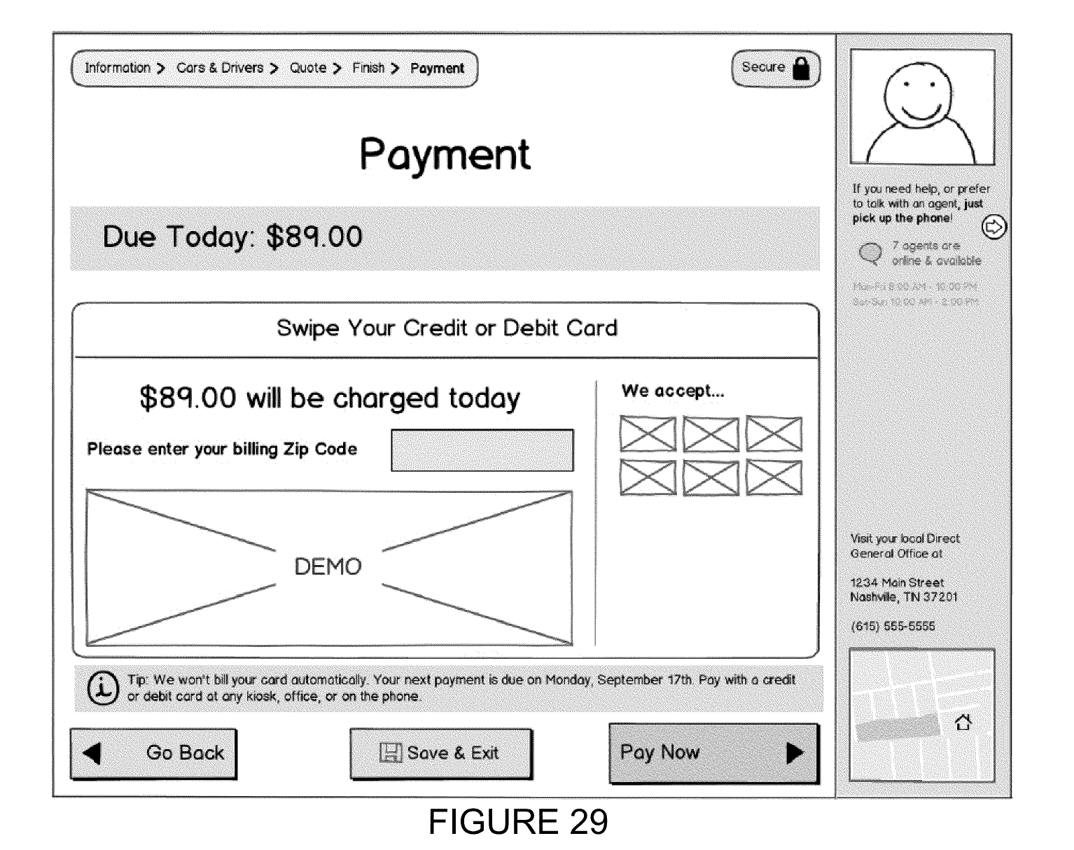

After processing the additional requests and information, the “final price” quote is provided, as seen in FIG. 24. The user can determine why the price changed 70 from previous quotes, if it has. The user is able to review all of the coverage details and information 72, add or change vehicles or drivers 74, and edit or remove additional products 76, as seen in FIG. 25. When satisfied, the user selects the “purchase” option, and proceeds to enter contact information (as seen in FIG. 26), before being presented with payment options, as seen in FIGS. 27-29. The user can pay the amount in full for a time period (e.g., 6 months), or pay monthly, with the upfront payment made at the time. The kiosk has the ability to accept payments in cash (and give change), by check, by credit or debit cards, or by other accepted forms of payment as known in the industry.

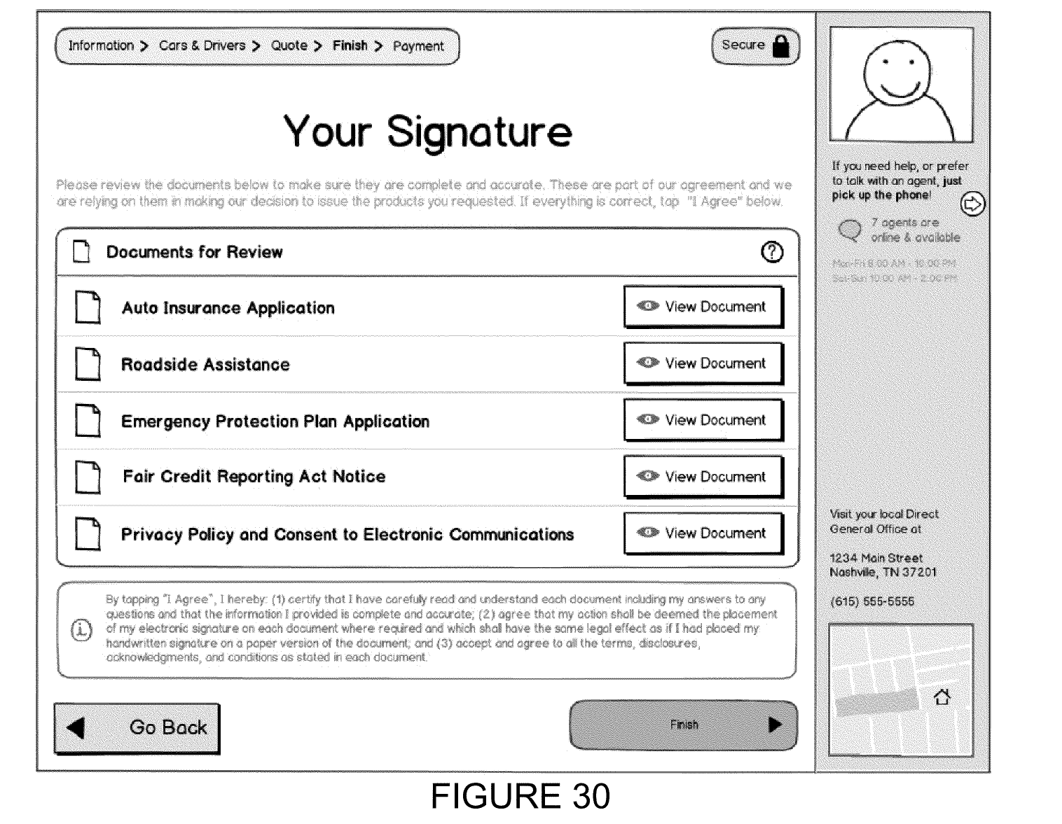

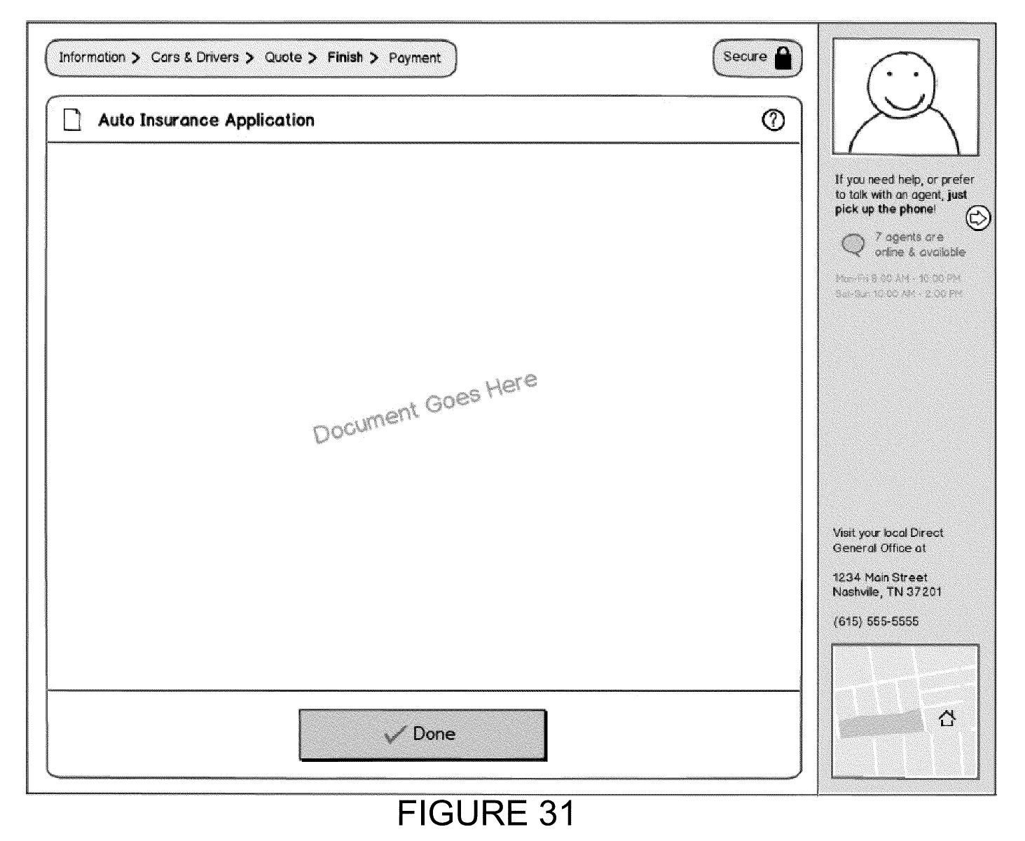

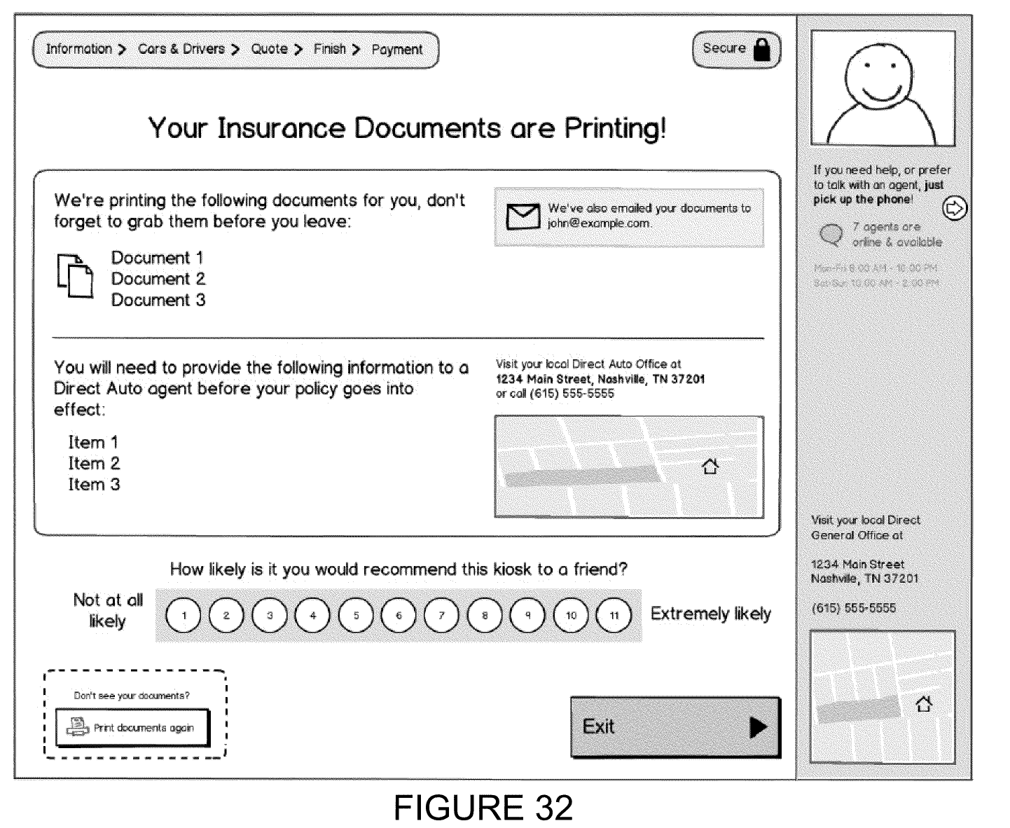

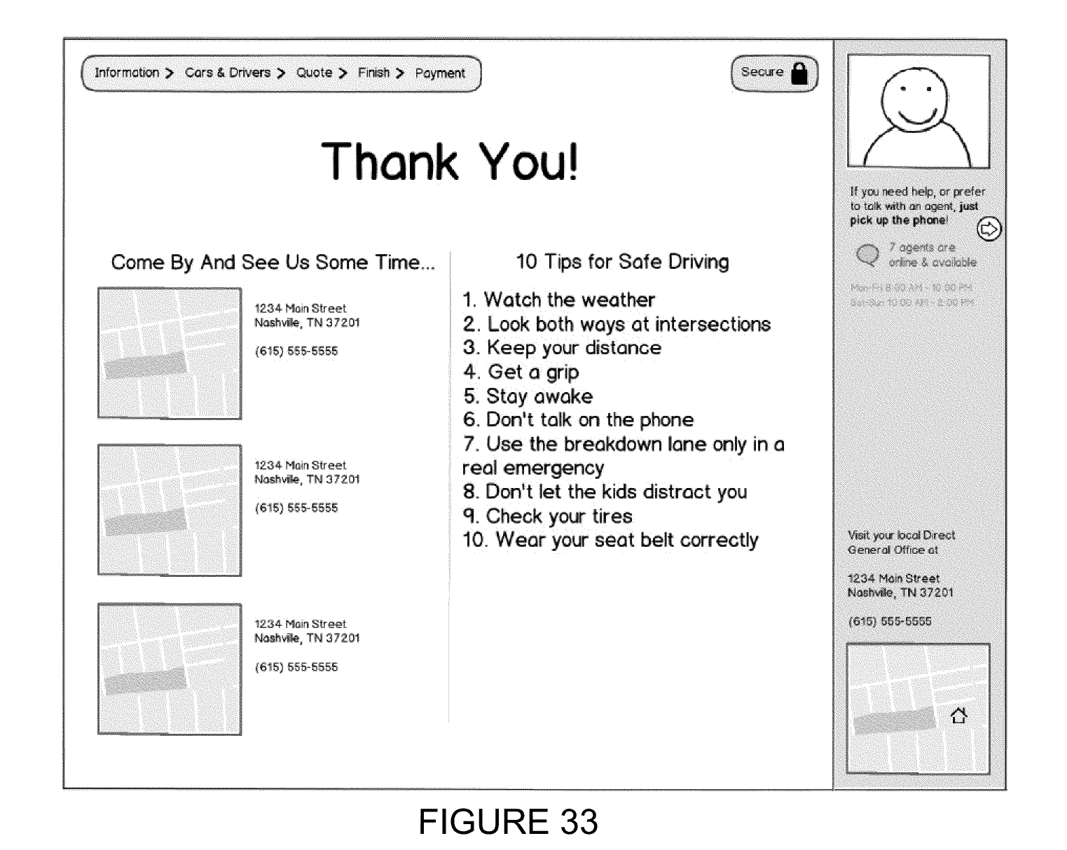

The user is then prompted to review the various documents forming the agreement, as shown in FIGS. 30-31, and when everything is correct, select the “I Agree” icon to indicate acceptance and agreement. The documents are then printed (as shown in FIG. 32). A closing screen with tips and other information may be shown at the end of the session (or at the end of any sessions with the kiosk), as seen in FIG. 33.

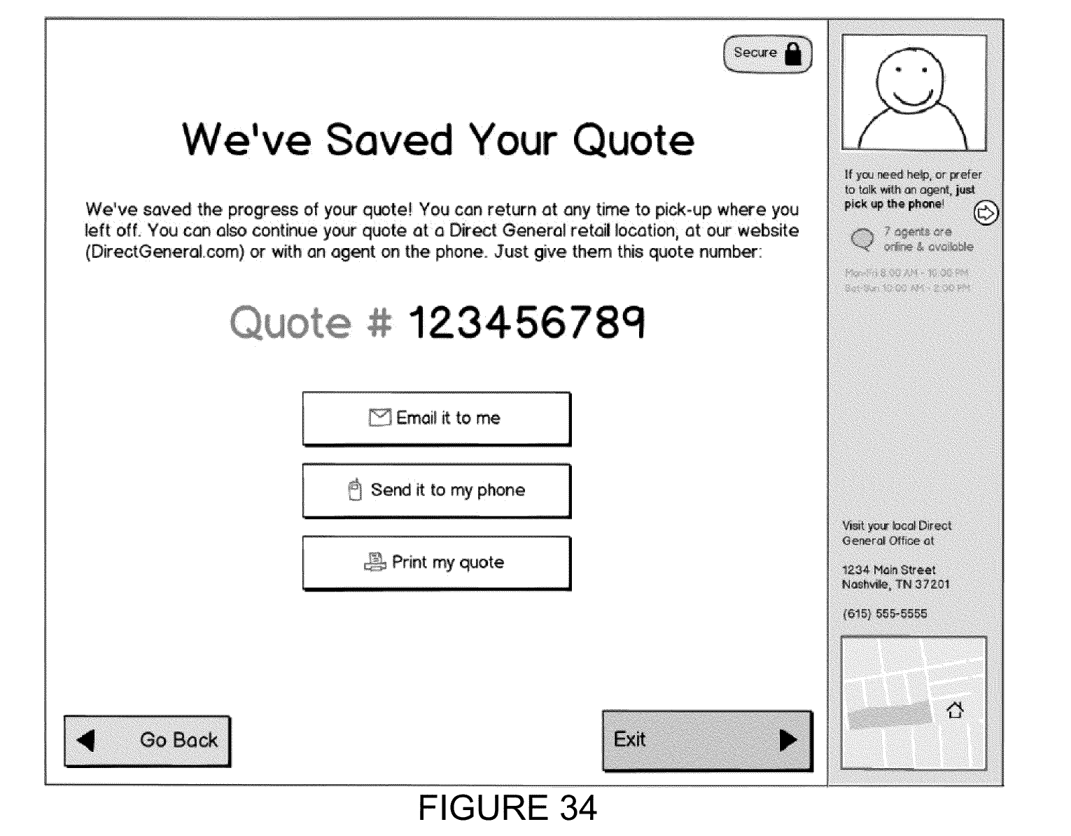

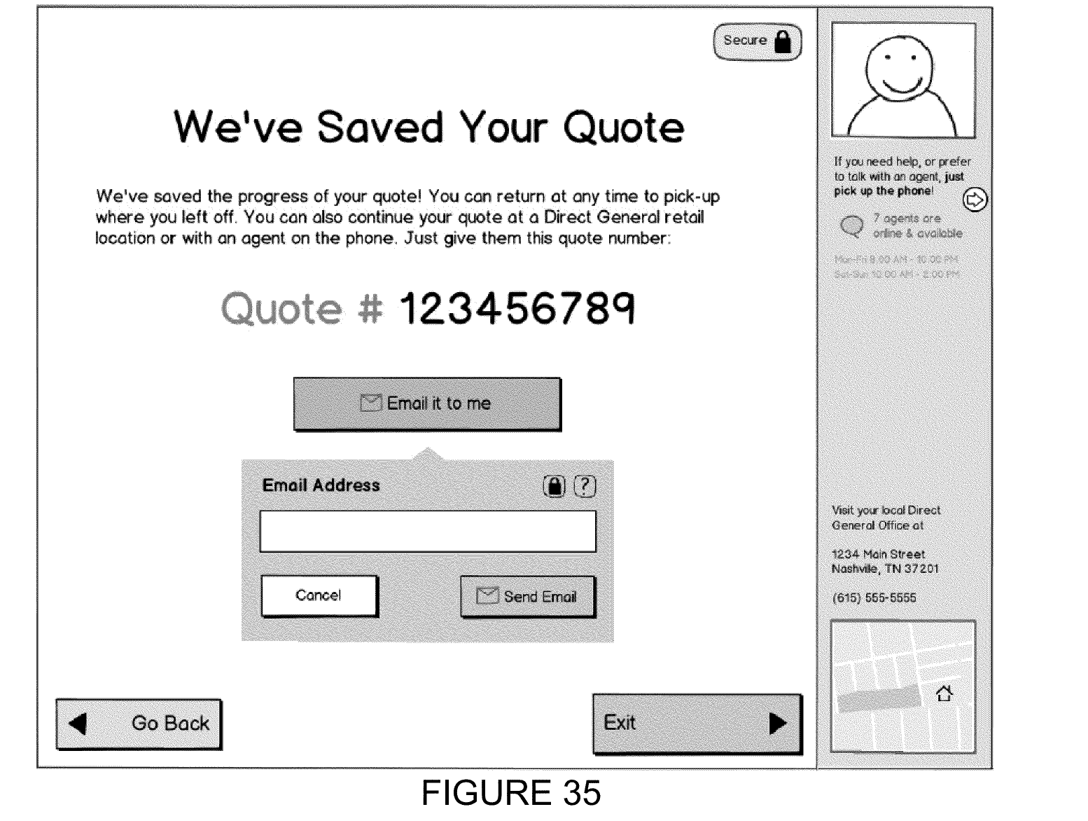

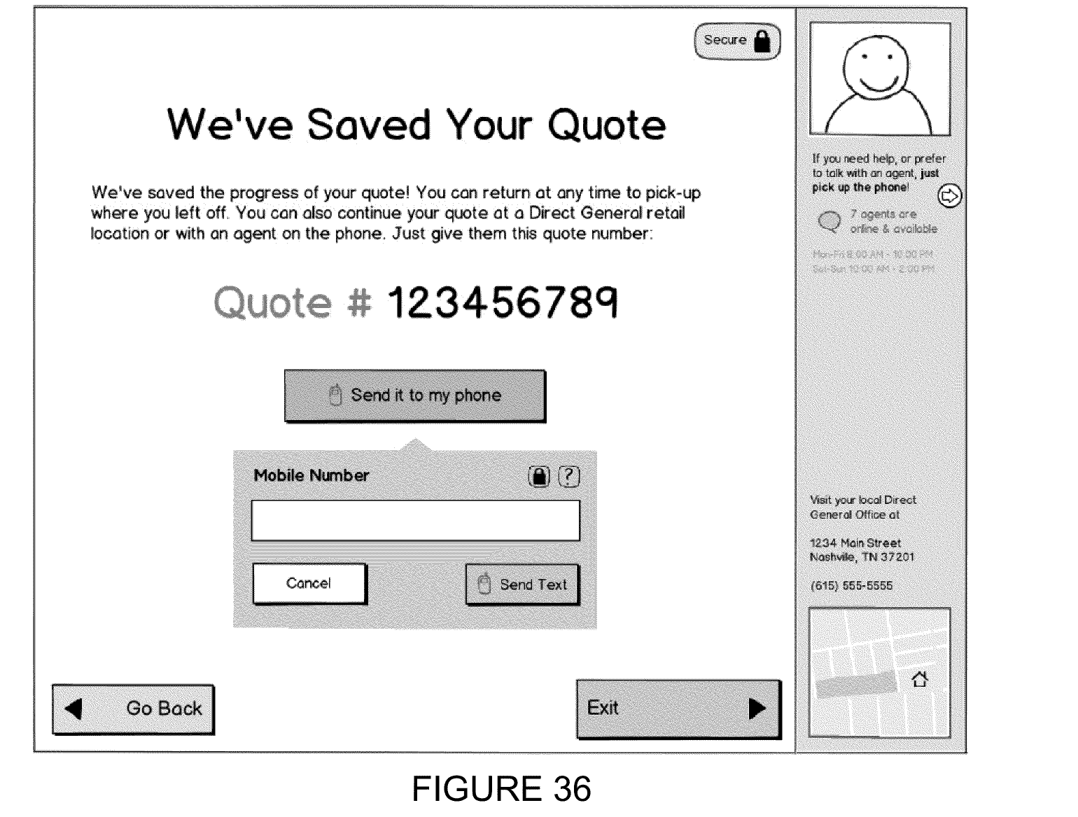

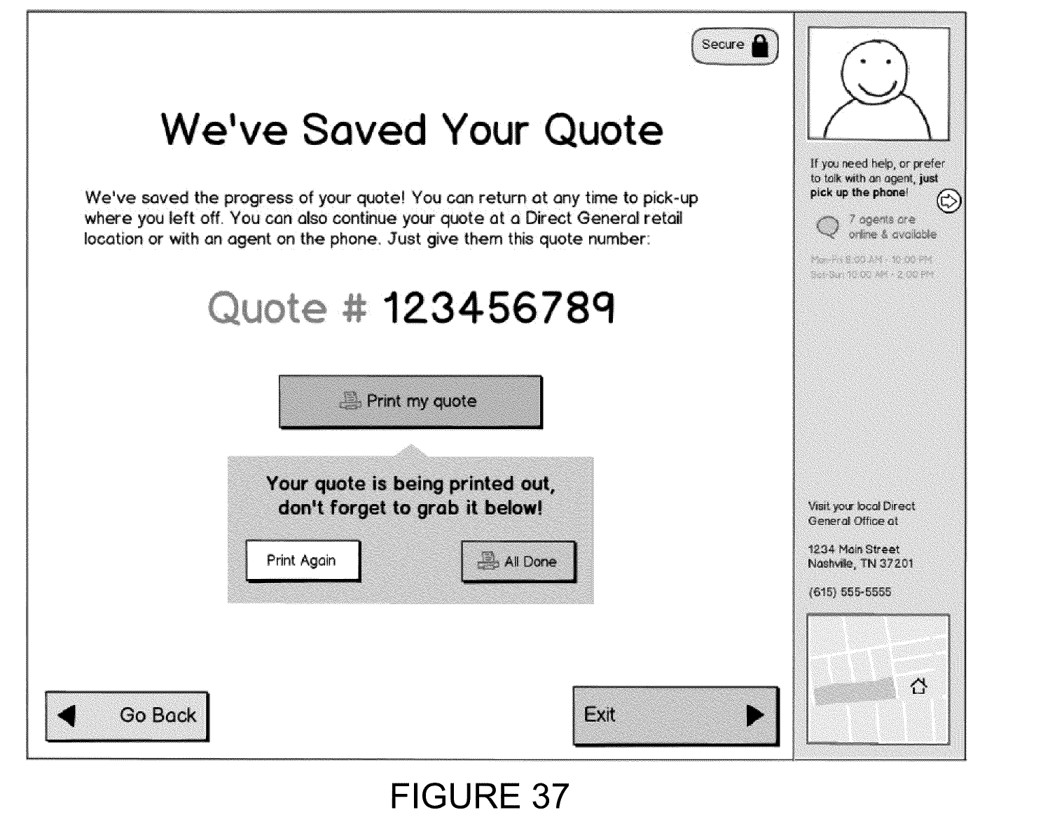

If the user decides to cancel the transaction, then any funds are refunded, and the information is saved for future use by the user. Also, as described above, the user can choose to halt the process at a number of points, and save the information for future use by the user. The user can choose to have the quote information emailed to them, messaged to a phone or personal computing device, or printed. FIGS. 34-37 show examples of the screens displayed to users regarding saved information.

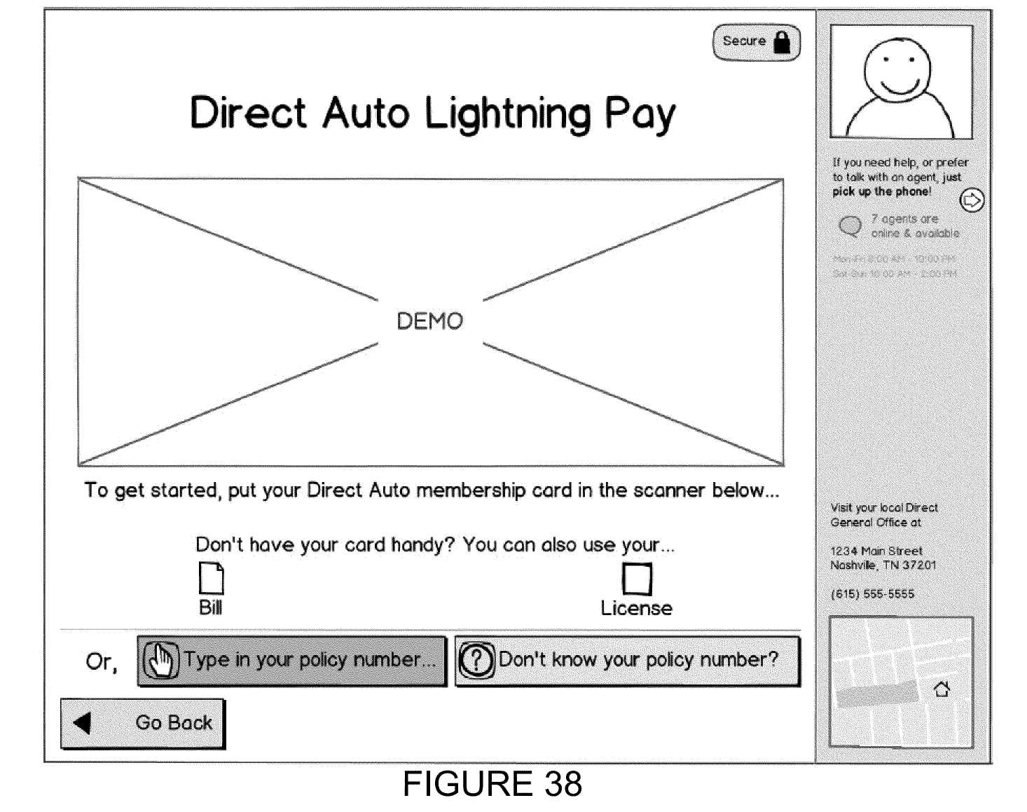

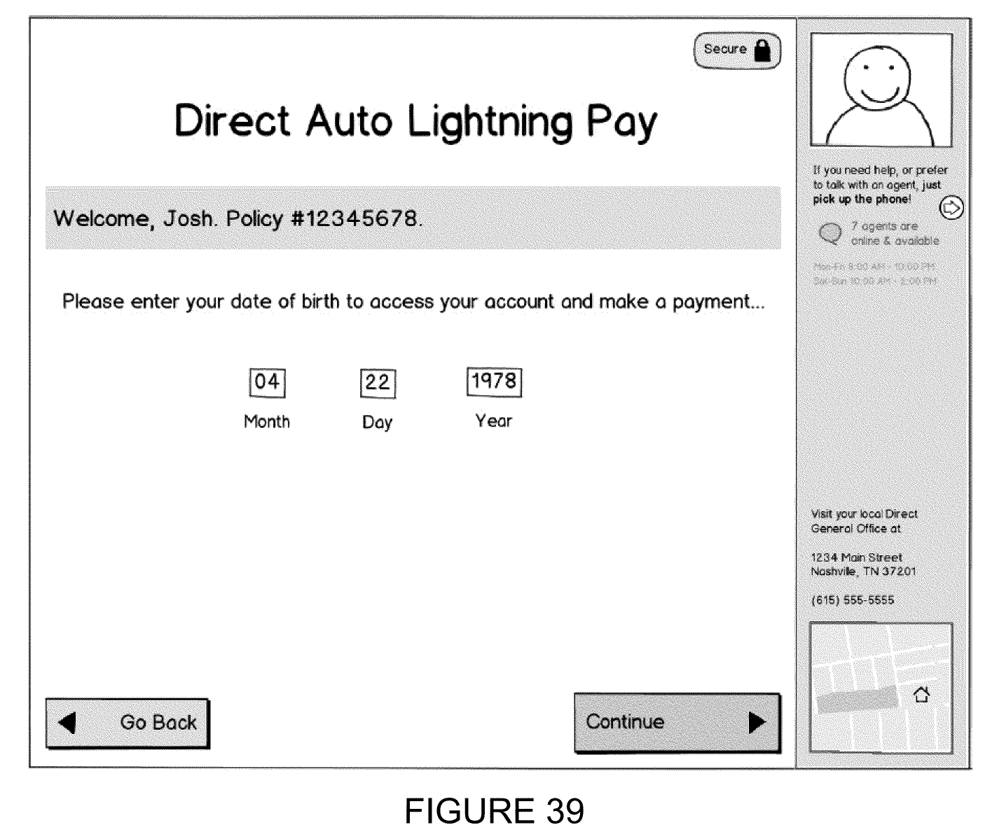

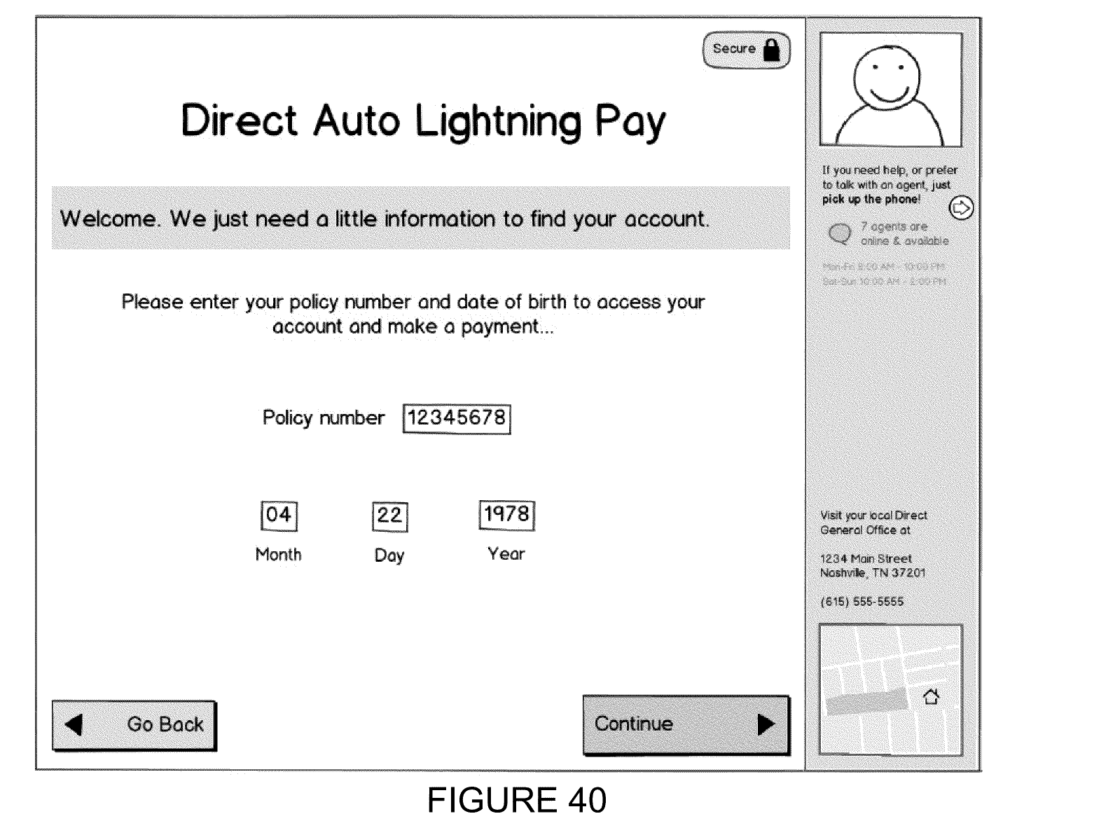

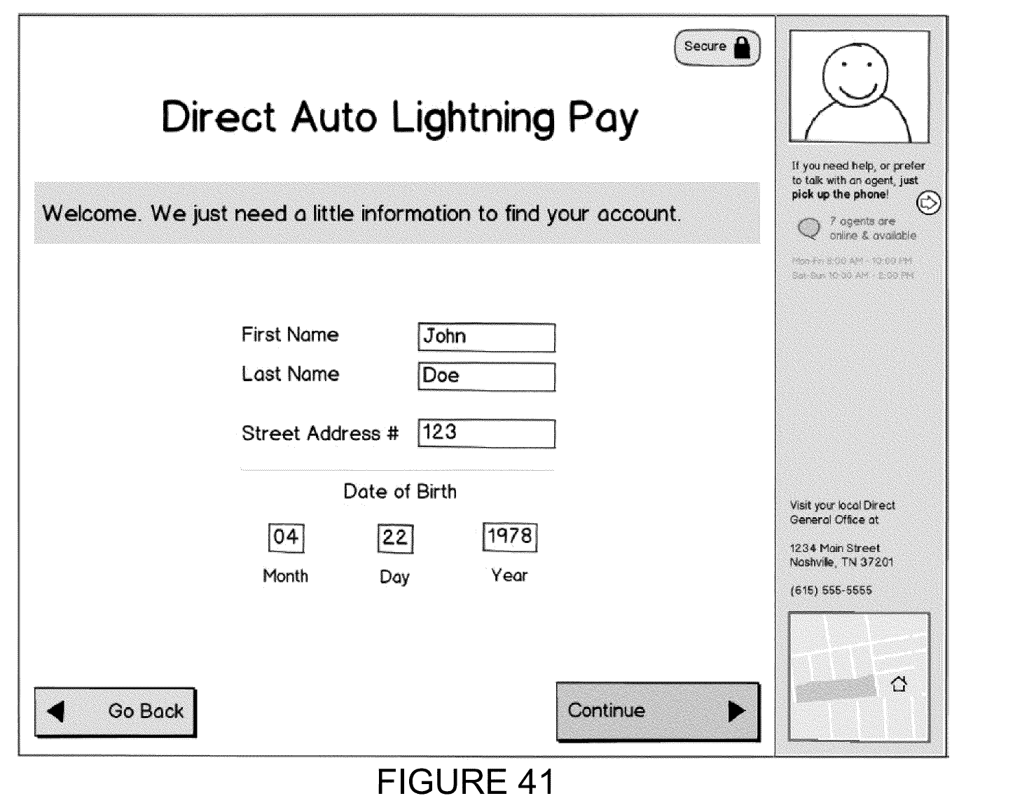

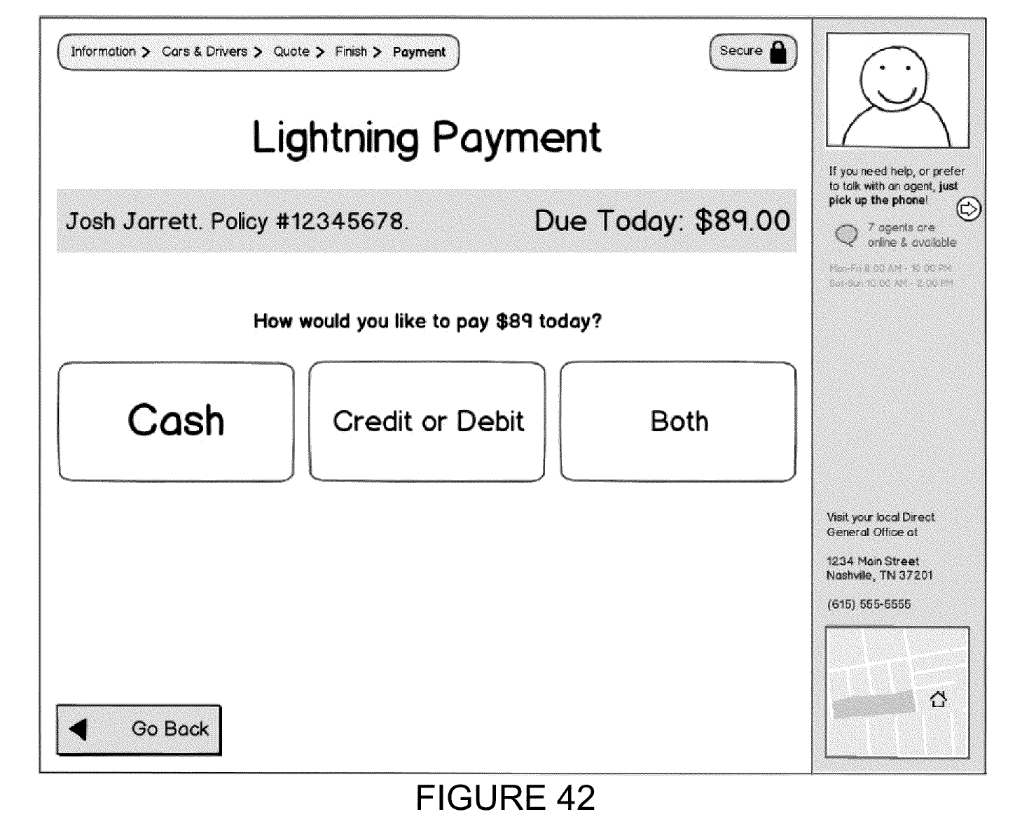

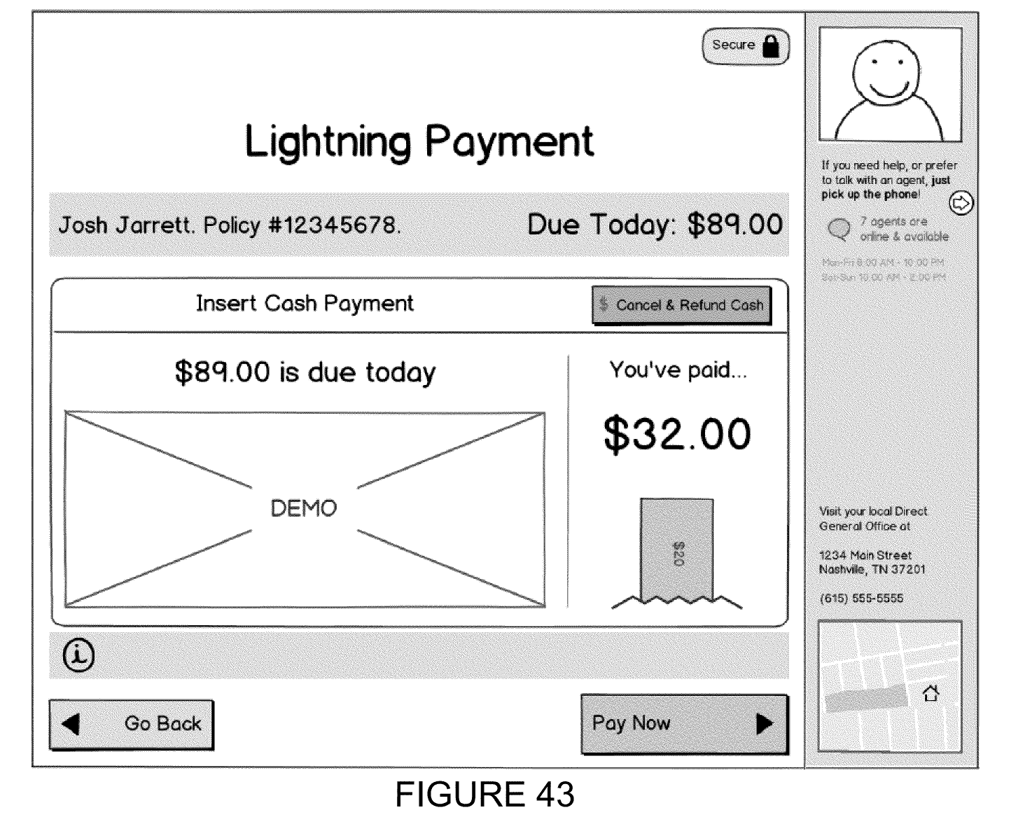

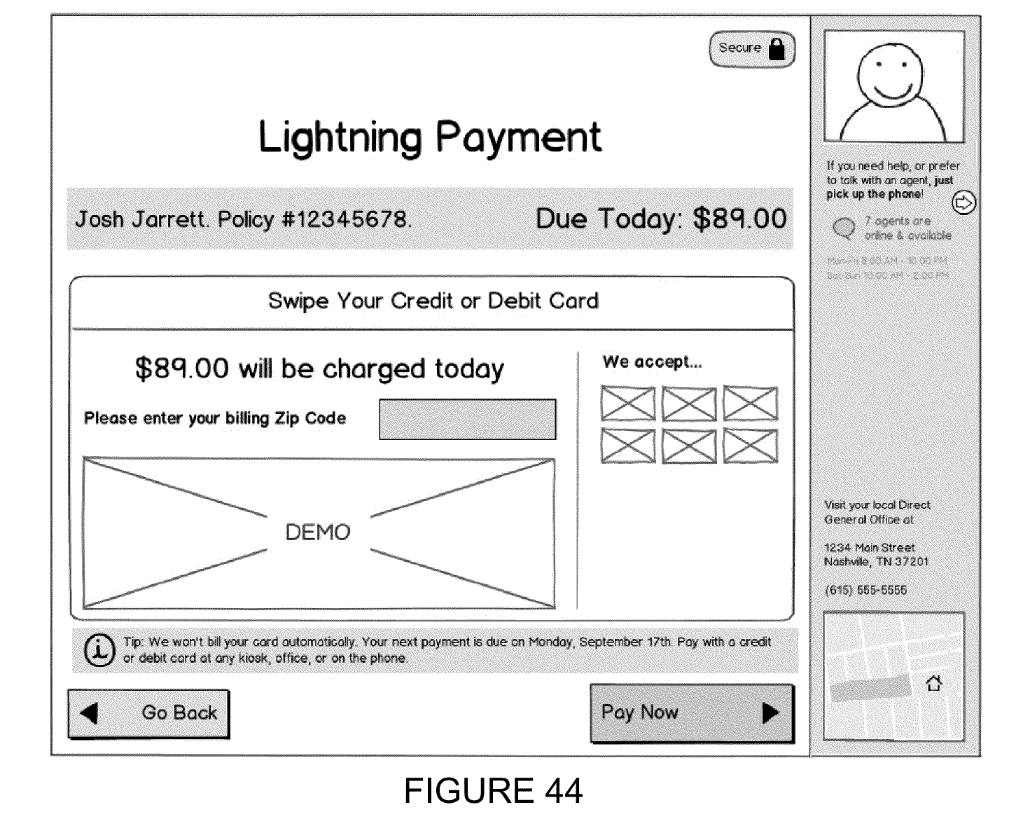

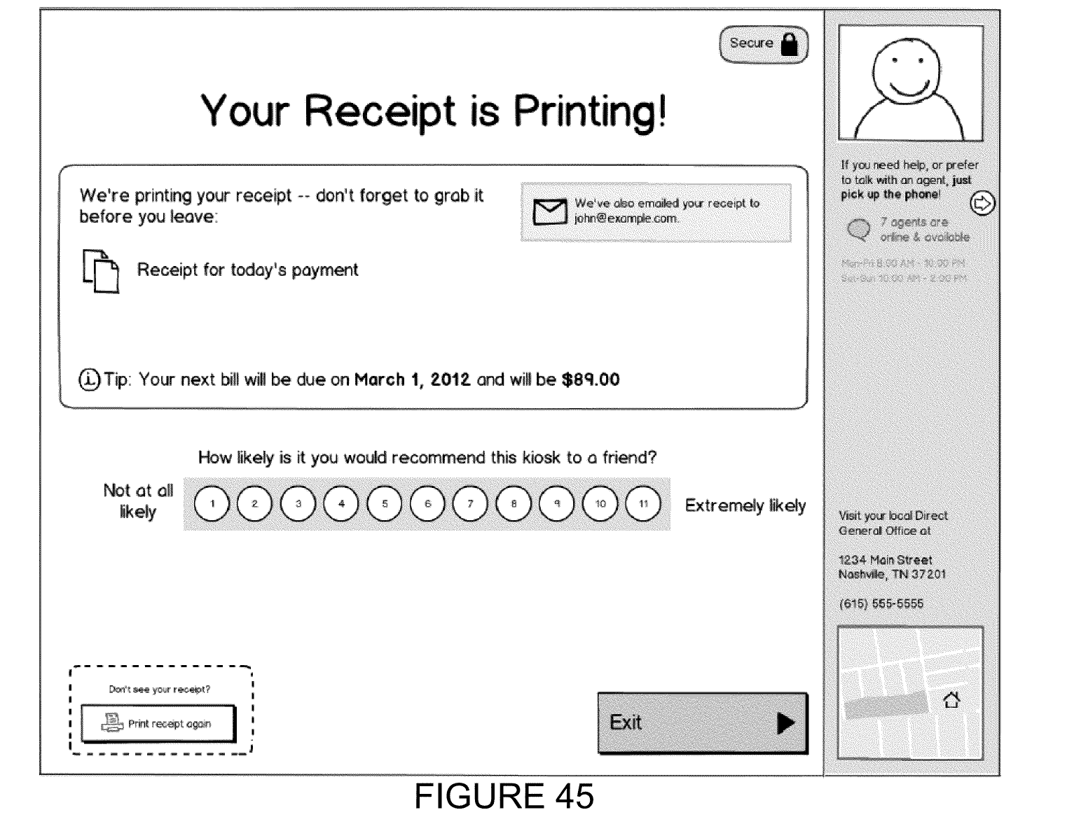

In some embodiments, the system may also be used to make payments on a policy (including policies issued as a lightning quote). The transaction can be initiated by entering the policy number, name and address information, or scanning a membership card, license, bill or other insurance document (see FIGS. 38-41). The user may be prompted to enter a birth date to confirm identification before proceeding, as seen in FIGS. 39 and 40. As seen in FIG. 42-46, the user is then provided with payment options and proceeds with making the desired payment (in a manner similar to that described above). During completion of the process, a customer satisfaction survey or the like may be taken, as seen in FIG. 45.

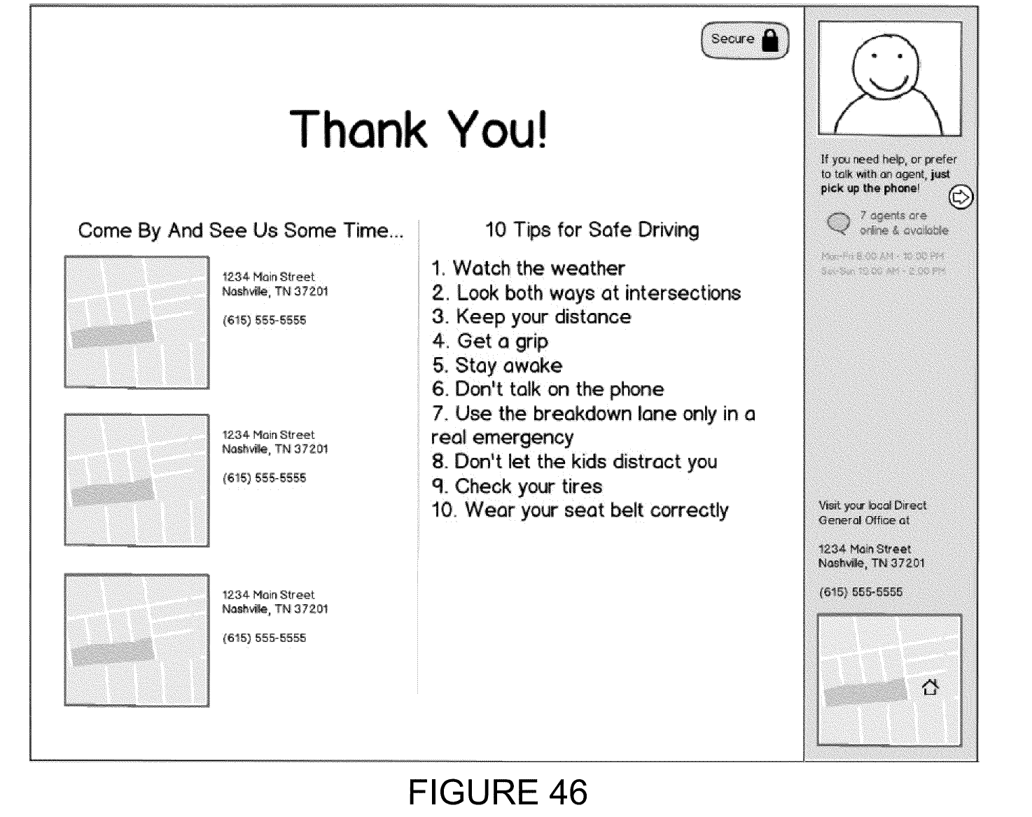

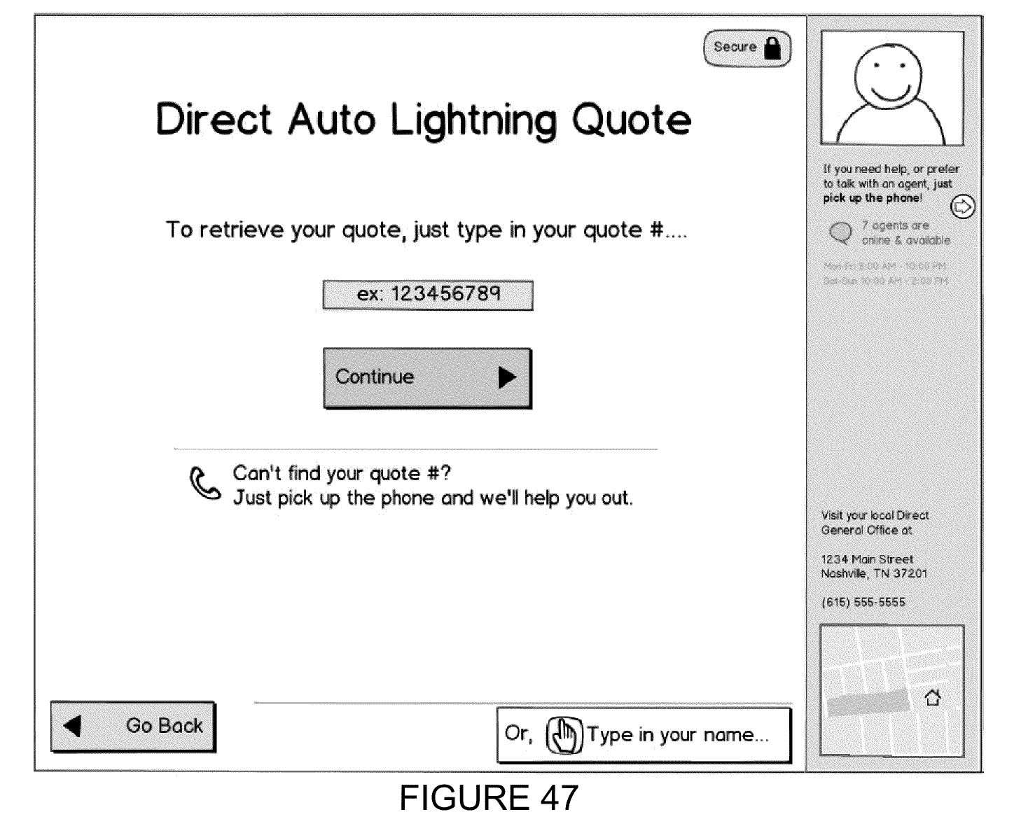

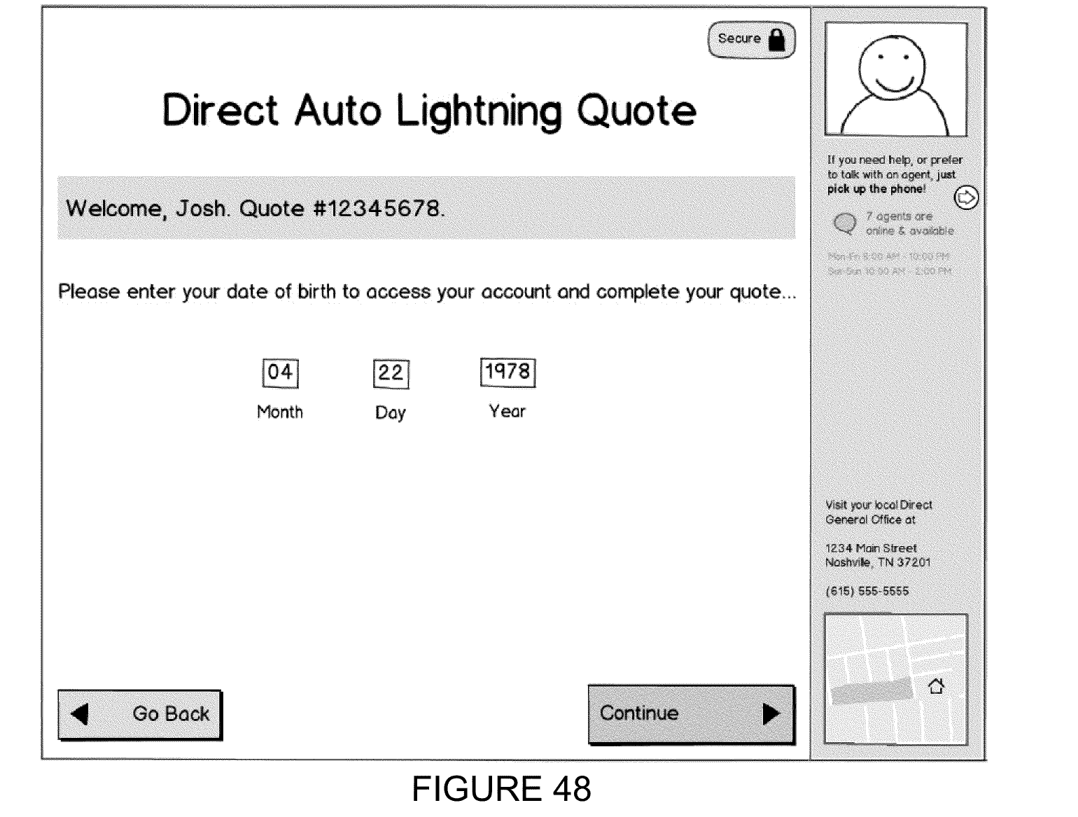

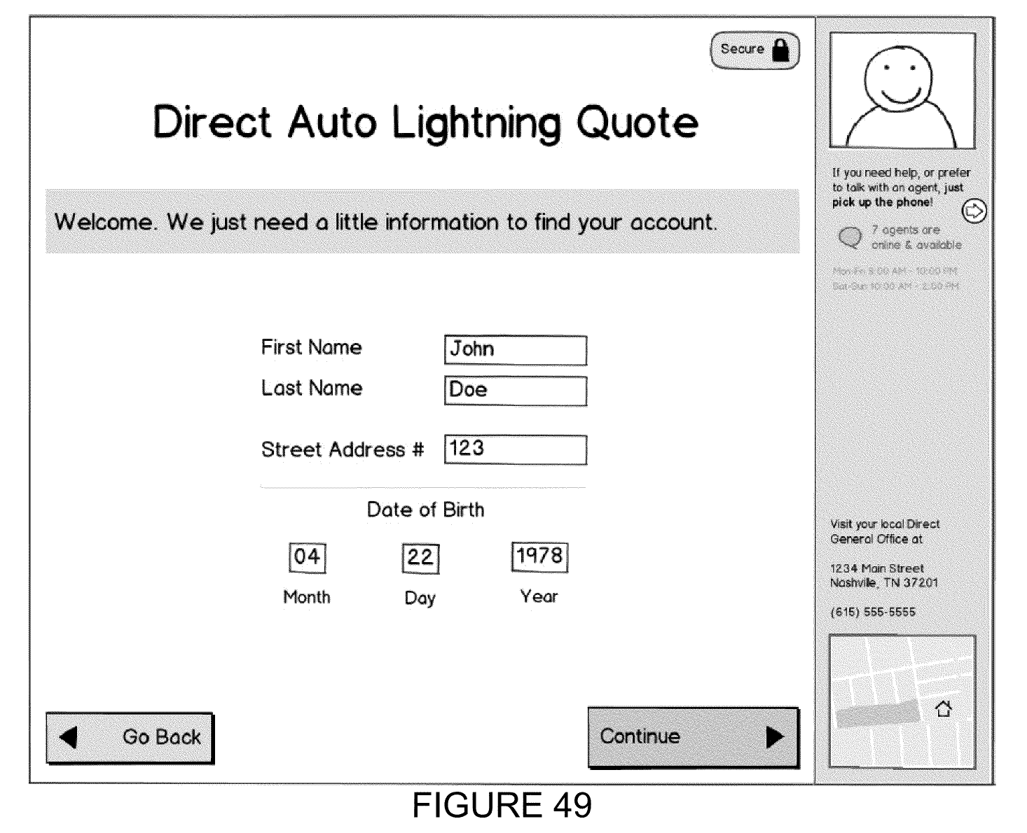

As seen in FIG. 46-49, the user also can use the kiosk to retrieve a quite obtained earlier, either at that kiosk, another kiosk, or another channel (e.g., online). The quote can be retrieved by entering the quote number, or name and address information. Once the quote is retrieved, the system will continue the flow from the point the retrieved quote was saved.

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. An apparatus for facilitating insurance-related transactions, comprising:
a kiosk with a computing device in electronic communication with a primary touch-screen display, a wired or wireless router or communication device, a cash acceptance and dispensing device, a magnetic stripe/barcode reader, and a printer;
wherein said computing device comprises a processor or microprocessor coupled to a computer memory;
further wherein said processor or microprocessor is programmed to perform at least one of the following steps:
provide an insurance quote;
bind an insurance policy; or
receive payment on an insurance policy.

2. The apparatus of claim 1, further comprising a secondary display screen attached to the kiosk, wherein the secondary display screen shows advertisements, pictures or videos to attract users to the kiosk.

4. The apparatus of claim 1, wherein the kiosk further comprises a gift card dispenser.

5. The apparatus of claim 1, wherein the kiosk further comprises a video camera or webcam, a scanner, a microphone, a speaker, a telephone, and a card printer.

6. The apparatus of claim 1, further wherein said processor or microprocessor is programmed to perform at least one of the following steps:
retrieve an insurance quote;
file an insurance claim;
endorse an insurance policy;
renew an insurance policy; or
provide help from an insurance agent or representative in a location remote from the kiosk.

7. The apparatus of claim 1, further wherein said processor or microprocessor is programmed to perform the following steps:
receive applications for small loans, microloans, or premium financing; and
provide said small loans, microloans, or premium financing.

8. The apparatus of claim 1, further wherein said processor or microprocessor is programmed to provide a gift card upon completion of certain transactions at the kiosk.

9. The apparatus of claim 8, wherein the gift card is for use at the location of the kiosk.

10. A non-transitory computer-readable storage medium with an executable program stored thereon, wherein the program instructs a processor or microprocessor to perform the following steps:
prompting a user to provide identification information;
automatically retrieving insurance-related information based upon the identification information;
automatically calculating an insurance quote based upon said insurance-related information within approximately 60 seconds or less of initiating the calculation; and
providing the insurance quote to the user.

11. The medium of claim 10, wherein the identification information for the user comprises at least one of the following: name and address, phone number, driver's license number, or social security number.

12. The medium of claim 10, wherein the storage medium is located inside a portable kiosk.

13. The medium of claim 12, wherein the kiosk comprises a display screen, at least one input device, and a scanner.

14. The medium of claim 13, wherein the identification information is obtained from the user by scanning the user's driver license, identification card, insurance card, or other insurance documents or bills.

15. The medium of claim 10, wherein the insurance-related information comprises vehicle information and driver information related to the user, which may include prior insurance coverage information, and said insurance-related information is automatically retrieved after scanning the user's driver license, identification card, insurance card, or bill.

16. A computer-implemented method of providing an insurance quote to a user, comprising the steps of:
prompting, using a processor or microprocessor in electronic communication with a computing device, a user to provide identification information;
automatically retrieving insurance-related information based upon the identification information;
automatically calculating, using the processor or microprocessor, an insurance quote based upon said insurance-related information within approximately 60 seconds or less of initiating the calculation; and
providing the insurance quote to the user.

17. The method of claim 16, wherein the computing device is contained in a stand-alone kiosk.

18. The method of claim 16, wherein the computing device comprises a scanner or camera.

19. The method of claim 18, wherein the identification information is obtained solely by scanning, using the scanner or camera, a driver license, identification card, insurance card, or bill presented by the user.

20. The method of claim 19, wherein the insurance-related information is retrieved based upon the scanned information from the user.
